(19) United States
(12) Patent Application Publication
(10) Pub. No.: US 2025/0175219 A1
(43) Pub. Date: May 29, 2025

(54) TECHNIQUES FOR IMPLEMENTING RECONFIGURABLE INTELLIGENT SURFACES IN MULTIPLE TRANSMISSION AND RECEPTION POINT COMMUNICATIONS

(71) Applicant: QUALCOMM INCORPORATED, San Diego, CA (US)

(72) Inventors: Ahmed Elshafie, San Diego, CA (US); Hung Dinh Ly, San Diego, CA (US); Yu Zhang, San Diego, CA (US)

(21) Appl. No.: 18/729,483

(22) PCT Filed: Mar. 15, 2022
(86) PCT No.: PCT/CN2022/080937

§ 371 Date: Jul. 16, 2024

(51) Int. Cl. H04B 7/04

(52) U.S. Cl. CPC H04B 7/04026

(57) ABSTRACT

Methods, systems, and devices for wireless communications are described. A reconfigurable intelligent surface (RIS) controller may transmit a first message indicating a class of at least a first RIS of one or more RISs served by the RIS controller. The class may be associated with one or more capabilities of the first RIS. The RIS controller may receive a second message that includes an indication of one or more identifiers associated with the first RIS, where a quantity of the one or more identifiers may be associated with the first RIS based on the class associated with the first RIS. The RIS controller may receive a third message indicating, via the one or more identifiers, a configuration for the first RIS for communications between the first RIS and one or more network entities.

### CROSS REFERENCE

The present Application is a 371 national stage filing of International PCT Application No. PCT/CN2022/080937 by Elshafie et al. entitled “TECHNIQUES FOR IMPLEMENTING RECONFIGURABLE INTELLIGENT SURFACES IN MULTIPLE TRANSMISSION AND RECEPTION POINT COMMUNICATIONS,” filed Mar. 15, 2022, which is assigned to the assignee hereof, and which is expressly incorporated by reference in its entirety herein.

### FIELD OF TECHNOLOGY

The following relates to wireless communications, including techniques for implementing reconfigurable intelligent surfaces (RISs) in multiple transmission and reception point (mTRP) communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some wireless communications systems may support beamforming techniques for communications between wireless devices. In some examples, wireless communications systems may include a relaying device, such as a reconfigurable intelligent surface (RIS), to facilitate transmissions between wireless devices. A relaying device may include a quantity of reflective, electrically-controllable elements. The relaying device may reflect transmissions in a specific direction based on a current configuration of the relaying device elements. For example, a relaying device may receive a beamformed communication at an angle of incidence and may reflect the beamformed communication at one or more angles different from the angle of incidence. In some cases, methods for using such a relaying device to support communications between multiple devices may be improved.

### SUMMARY

The described techniques relate to improved methods, systems, devices, and apparatuses that support techniques for implementing reconfigurable intelligent surfaces (RISs) in multiple transmission and reception point (mTRP) communications. For example, the described techniques provide for improved methods of utilizing a RIS to extend communications in a wireless communication system. The techniques described herein allow a RIS controller to transmit a first message indicating a class of at least a first RIS of one or more RISs served by the RIS controller. The class may be associated with one or more capabilities of the first RIS. In some cases, the first message may include capability information (e.g., a class) per RIS controller, or per RIS of the RIS controller, such as the first RIS. For instance, the RIS controller may signal a number of RIS elements of one or more RISs served by the RIS controller, a number of sub-RISs of the one or more RIS surfaces, a number of RISs served by the RIS controller, etc. The RIS controller may receive a second message that includes an indication of one or more identifiers associated with at least the first RIS, where a quantity of the one or more identifiers may be associated with the first RIS based on the class associated with the first RIS. The RIS controller may receive a third message indicating, via the one or more identifiers, a configuration for the first RIS for communications between the first RIS and one or more network entities.

A method for wireless communications at a RIS controller is described. The method may include transmitting a first message indicating a class of a first RIS of one or more RISs served by the RIS controller, the class associated with one or more capabilities of the first RIS, receiving a second message that includes an indication of one or more identifiers associated with the first RIS, a quantity of the one or more identifiers associated with the first RIS based on the class associated with the first RIS, and receiving a third message indicating, via the one or more identifiers, a configuration for the first RIS for communications between the first RIS and one or more network entities.

An apparatus for wireless communications is described. The apparatus may include a processor, memory coupled with the processor, and instructions stored in the memory. The instructions may be executable by the processor to cause the apparatus to transmit a first message indicating a class of a first RIS of one or more RISs served by the RIS controller, the class associated with one or more capabilities of the first RIS, receive a second message that includes an indication of one or more identifiers associated with the first RIS, a quantity of the one or more identifiers associated with the first RIS based on the class associated with the first RIS, and receive a third message indicating, via the one or more identifiers, a configuration for the first RIS for communications between the first RIS and one or more network entities.

Another apparatus for wireless communications is described. The apparatus may include means for transmitting a first message indicating a class of a first RIS of one or more RISs served by the RIS controller, the class associated with one or more capabilities of the first RIS, means for receiving a second message that includes an indication of one or more identifiers associated with the first RIS, a quantity of the one or more identifiers associated with the first RIS based on the class associated with the first RIS, and means for receiving a third message indicating, via the one or more identifiers, a configuration for the first RIS for communications between the first RIS and one or more network entities.

A non-transitory computer-readable medium storing code for wireless communications is described. The code may include instructions executable by a processor to transmit a first message indicating a class of a first RIS of one or more RISs served by the RIS controller, the class associated with one or more capabilities of the first RIS, receive a second message that includes an indication of one or more identifiers associated with the first RIS, a quantity of the one or more identifiers associated with the first RIS based on the class associated with the first RIS, and receive a third message indicating, via the one or more identifiers, a configuration for the first RIS for communications between the first RIS and one or more network entities.

In some examples of the method, apparatuses, and non-transitory computer-readable medium described herein, transmitting the first message may include operations, features, means, or instructions for transmitting the first message indicating a number of RIS elements of the first RIS.

In some examples of the method, apparatuses, and non-transitory computer-readable medium described herein, transmitting the first message may include operations, features, means, or instructions for transmitting the first message indicating a number of sub-RISs supported by the first RIS.

In some examples of the method, apparatuses, and non-transitory computer-readable medium described herein, transmitting the first message may include operations, features, means, or instructions for transmitting the first message indicating a number of RIS elements the first RIS supports per sub-RIS.

In some examples of the method, apparatuses, and non-transitory computer-readable medium described herein, transmitting the first message may include operations, features, means, or instructions for transmitting the first message indicating one or more codebook-based or non-codebook based beams supported by the first RIS.

In some examples of the method, apparatuses, and non-transitory computer-readable medium described herein, transmitting the first message may include operations, features, means, or instructions for transmitting the first message indicating a duration of time in which the first RIS may be capable of switching between configurations of the first RIS.

In some examples of the method, apparatuses, and non-transitory computer-readable medium described herein, transmitting the first message may include operations, features, means, or instructions for transmitting the first message indicating a granularity of weights associated with RIS elements of the first RIS.

In some examples of the method, apparatuses, and non-transitory computer-readable medium described herein, transmitting the first message may include operations, features, means, or instructions for transmitting the first message indicating whether the first RIS may be capable of switching configurations across frequencies.

In some examples of the method, apparatuses, and non-transitory computer-readable medium described herein, transmitting the first message may include operations, features, means, or instructions for transmitting the first message indicating a bandwidth size over which the first RIS may be capable of switching configurations.

In some examples of the method, apparatuses, and non-transitory computer-readable medium described herein, transmitting the first message may include operations, features, means, or instructions for transmitting the first message indicating one or more modem types the first RIS may be configured with.

Some examples of the method, apparatuses, and non-transitory computer-readable medium described herein may further include operations, features, means, or instructions for receiving a signal indicating a set of one or more communication scheme identifiers, each communication scheme identifier associated with a set of one or more network entities and a communication type, where the communication type may be one of spatial division multiplexing, frequency division multiplexing, or time division multiplexing.

Some examples of the method, apparatuses, and non-transitory computer-readable medium described herein may further include operations, features, means, or instructions for receiving a trigger to perform a training procedure, the trigger including a communication scheme identifier from the set of one or more communication scheme identifiers, a set of network entities involved in the training procedure, the communication type associated with the training procedure, a RIS identifier to be used for the training procedure, or a combination thereof and performing the training procedure in accordance with the trigger to determine one or more preferred RIS beams associated with the training procedure.

In some examples of the method, apparatuses, and non-transitory computer-readable medium described herein, receiving the third message may include operations, features, means, or instructions for receiving the third message indicating a communication scheme identifier, the communication scheme identifier indicative of the configuration for the first RIS for the communications between the first RIS and the one or more network entities.

In some examples of the method, apparatuses, and non-transitory computer-readable medium described herein, the communication scheme identifier may be included in a transmission configuration indicator state indication, a quasi-colocation indication, or both.

In some examples of the method, apparatuses, and non-transitory computer-readable medium described herein, the quasi-colocation indication may be associated with quasi-colocation type D.

In some examples of the method, apparatuses, and non-transitory computer-readable medium described herein, the configuration for the first RIS indicated via the one or more identifiers may be included in a transmission configuration indicator state indication, a quasi-colocation indication, or both.

In some examples of the method, apparatuses, and non-transitory computer-readable medium described herein, the quasi-colocation indication may be associated with quasi-colocation type D.

Some examples of the method, apparatuses, and non-transitory computer-readable medium described herein may further include operations, features, means, or instructions for receiving a signal indicating one or more parameters associated with the communications between the first RIS and the one or more network entities, where the one or more network entities may be each a TRP.

In some examples of the method, apparatuses, and non-transitory computer-readable medium described herein, the one or more parameters include allocated resources, the one or more network entities, a communication type, or a combination thereof for the communications between the first RIS and the one or more network entities.

In some examples of the method, apparatuses, and non-transitory computer-readable medium described herein, the signal may be received with the third message, or separate from the third message.

In some examples of the method, apparatuses, and non-transitory computer-readable medium described herein, the signal may be included in a downlink control information message intended for the RIS controller, or included in a group-common downlink control information message.

Some examples of the method, apparatuses, and non-transitory computer-readable medium described herein may further include operations, features, means, or instructions for adjusting the configuration of the first RIS in accordance with the configuration indicated in the third message.

In some examples of the method, apparatuses, and non-transitory computer-readable medium described herein, receiving the third message may include operations, features, means, or instructions for receiving a downlink control information message including the third message.

In some examples of the method, apparatuses, and non-transitory computer-readable medium described herein, the first RIS may be associated with a set of frequency resources, one or more user equipment's (UEs), or a combination thereof.

In some examples of the method, apparatuses, and non-transitory computer-readable medium described herein, the first RIS includes one or more sub-RISs.

In some examples of the method, apparatuses, and non-transitory computer-readable medium described herein, each sub-RIS may be associated with a set of frequency resources, one or more UEs, or a combination thereof.

In some examples of the method, apparatuses, and non-transitory computer-readable medium described herein, the communications between the first RIS and the one or more network entities include downlink communications, uplink communications, or a combination thereof.

A method for wireless communications at a network entity is described. The method may include receiving a first message indicating a class of a first RIS of one or more RISs served by a RIS controller, the class associated with one or more capabilities of the first RIS, transmitting a second message that includes an indication of one or more identifiers associated with the first RIS, a quantity of the one or more identifiers associated with the first RIS based on the class associated with the first RIS, and transmitting a third message indicating, via the one or more identifiers, a configuration for the first RIS for communications between the first RIS and one or more network entities.

An apparatus for wireless communications is described. The apparatus may include a processor, memory coupled with the processor, and instructions stored in the memory. The instructions may be executable by the processor to cause the apparatus to receive a first message indicating a class of a first RIS of one or more RISs served by a RIS controller, the class associated with one or more capabilities of the first RIS, transmit a second message that includes an indication of one or more identifiers associated with the first RIS, a quantity of the one or more identifiers associated with the first RIS based on the class associated with the first RIS, and transmit a third message indicating, via the one or more identifiers, a configuration for the first RIS for communications between the first RIS and one or more network entities.

Another apparatus for wireless communications is described. The apparatus may include means for receiving a first message indicating a class of a first RIS of one or more RISs served by a RIS controller, the class associated with one or more capabilities of the first RIS, means for transmitting a second message that includes an indication of one or more identifiers associated with the first RIS, a quantity of the one or more identifiers associated with the first RIS based on the class associated with the first RIS, and means for transmitting a third message indicating, via the one or more identifiers, a configuration for the first RIS for communications between the first RIS and one or more network entities.

A non-transitory computer-readable medium storing code for wireless communications is described. The code may include instructions executable by a processor to receive a first message indicating a class of a first RIS of one or more RISs served by a RIS controller, the class associated with one or more capabilities of the first RIS, transmit a second message that includes an indication of one or more identifiers associated with the first RIS, a quantity of the one or more identifiers associated with the first RIS based on the class associated with the first RIS, and transmit a third message indicating, via the one or more identifiers, a configuration for the first RIS for communications between the first RIS and one or more network entities.

In some examples of the method, apparatuses, and non-transitory computer-readable medium described herein, receiving the first message may include operations, features, means, or instructions for receiving the first message indicating a number of RIS elements of the first RIS.

In some examples of the method, apparatuses, and non-transitory computer-readable medium described herein, receiving the first message may include operations, features, means, or instructions for receiving the first message indicating a number of sub-RISs supported by the first RIS.

In some examples of the method, apparatuses, and non-transitory computer-readable medium described herein, receiving the first message may include operations, features, means, or instructions for receiving the first message indicating a number of RIS elements the first RIS supports per sub-RIS.

In some examples of the method, apparatuses, and non-transitory computer-readable medium described herein, receiving the first message may include operations, features, means, or instructions for receiving the first message indicating one or more codebook-based or non-codebook based beams supported by the first RIS.

In some examples of the method, apparatuses, and non-transitory computer-readable medium described herein, receiving the first message may include operations, features, means, or instructions for receiving the first message indicating a duration of time in which the first RIS may be capable of switching between configurations of the first RIS.

In some examples of the method, apparatuses, and non-transitory computer-readable medium described herein, receiving the first message may include operations, features, means, or instructions for receiving the first message indicating a granularity of weights associated with RIS elements of the first RIS.

In some examples of the method, apparatuses, and non-transitory computer-readable medium described herein, receiving the first message may include operations, features, means, or instructions for receiving the first message indicating whether the first RIS may be capable of switching configurations across frequencies.

In some examples of the method, apparatuses, and non-transitory computer-readable medium described herein, receiving the first message may include operations, features, means, or instructions for receiving the first message indicating a bandwidth size over which the first RIS may be capable of switching configurations.

In some examples of the method, apparatuses, and non-transitory computer-readable medium described herein, receiving the first message may include operations, features, means, or instructions for receiving the first message indicating one or more modem types the first RIS may be configured with.

Some examples of the method, apparatuses, and non-transitory computer-readable medium described herein may further include operations, features, means, or instructions for transmitting a signal indicating a set of one or more communication scheme identifiers, each communication scheme identifier associated with a set of one or more network entities and a communication type, where the communication type may be one of spatial division multiplexing, frequency division multiplexing, or time division multiplexing.

Some examples of the method, apparatuses, and non-transitory computer-readable medium described herein may further include operations, features, means, or instructions for transmitting a trigger to perform a training procedure, the trigger including a communication scheme identifier from the set of one or more communication scheme identifiers, a set of network entities involved in the training procedure, the communication type associated with the training procedure, a RIS identifier to be used for the training procedure, or a combination thereof and performing the training procedure in accordance with the trigger to determine one or more preferred RIS beams associated with the training procedure by transmitting or receiving one or more reference signals to or from the first RIS, respectively.

In some examples of the method, apparatuses, and non-transitory computer-readable medium described herein, transmitting the third message may include operations, features, means, or instructions for transmitting the third message indicating a communication scheme identifier, the communication scheme identifier indicative of the configuration for the first RIS for the communications between the first RIS and the one or more network entities.

In some examples of the method, apparatuses, and non-transitory computer-readable medium described herein, the communication scheme identifier may be included in a transmission configuration indicator state indication, a quasi-colocation indication, or both.

In some examples of the method, apparatuses, and non-transitory computer-readable medium described herein, the quasi-colocation indication may be associated with quasi-colocation type D.

In some examples of the method, apparatuses, and non-transitory computer-readable medium described herein, the configuration for the first RIS indicated via the one or more identifiers may be included in a transmission configuration indicator state indication, a quasi-colocation indication, or both.

In some examples of the method, apparatuses, and non-transitory computer-readable medium described herein, the quasi-colocation indication may be associated with quasi-colocation type D.

Some examples of the method, apparatuses, and non-transitory computer-readable medium described herein may further include operations, features, means, or instructions for transmitting a signal indicating one or more parameters associated with the communications between the first RIS and the one or more network entities.

In some examples of the method, apparatuses, and non-transitory computer-readable medium described herein, the one or more parameters include allocated resources, the one or more network entities, a communication type, or a combination thereof for the communications between the first RIS and the one or more network entities.

In some examples of the method, apparatuses, and non-transitory computer-readable medium described herein, the signal may be received with the third message, or separate from the third message.

In some examples of the method, apparatuses, and non-transitory computer-readable medium described herein, the signal may be included in a downlink control information message intended for the RIS controller, or included in a group-common downlink control information message.

In some examples of the method, apparatuses, and non-transitory computer-readable medium described herein, transmitting the third message may include operations, features, means, or instructions for transmitting a downlink control information message including the third message.

In some examples of the method, apparatuses, and non-transitory computer-readable medium described herein, the first RIS may be associated with a set of frequency resources, one or more UEs, or a combination thereof.

In some examples of the method, apparatuses, and non-transitory computer-readable medium described herein, the first RIS includes one or more sub-RISs.

In some examples of the method, apparatuses, and non-transitory computer-readable medium described herein, each sub-RIS may be associated with a set of frequency resources, one or more UEs, or a combination thereof.

In some examples of the method, apparatuses, and non-transitory computer-readable medium described herein, the communications between the first RIS and the network entity include downlink communications, uplink communications, or a combination thereof.

### BRIEF DESCRIPTION OF THE DRAWINGS

FIG. 1 illustrates an example of a wireless communications system that supports techniques for implementing reconfigurable intelligent surfaces (RISs) in multiple transmission and reception point (mTRP) communications in accordance with one or more aspects of the present disclosure.

FIG. 2 illustrates an example of a wireless communications system that supports techniques for implementing RISs in mTRP communications in accordance with one or more aspects of the present disclosure.

FIGS. 3A, 3B, and 3C illustrate examples of communication schemes that support techniques for implementing RISs in mTRP communications in accordance with one or more aspects of the present disclosure.

FIG. 4 illustrates an example of a RIS that supports techniques for implementing RISs in mTRP communications in accordance with one or more aspects of the present disclosure.

FIG. 5 illustrates an example of a process flow that supports techniques for implementing RISs in mTRP communications in accordance with one or more aspects of the present disclosure.

FIGS. 6 and 7 show block diagrams of devices that support techniques for implementing RISs in mTRP communications in accordance with one or more aspects of the present disclosure.

FIG. 8 shows a block diagram of a communications manager that supports techniques for implementing RISs in mTRP communications in accordance with one or more aspects of the present disclosure.

FIG. 9 shows a diagram of a system including a device that supports techniques for implementing RISs in mTRP communications in accordance with one or more aspects of the present disclosure.

FIGS. 10 through 13 show flowcharts illustrating methods that support techniques for implementing RISs in mTRP communications in accordance with one or more aspects of the present disclosure.

### DETAILED DESCRIPTION

Some wireless communications systems may use reconfigurable intelligent surfaces (RISs) to increase cell coverage and channel diversity. For example, a RIS may redirect a beam transmitted from a network entity towards a user equipment (UE) in situations where the network entity may not be able to transmit directly to the UE. In some cases, the RIS may use an array of elements to redirect signals and the RIS may redirect the signals using particular weights. Accordingly, a RIS may be an example of a passive (e.g., low power) device that can reflect, refract, or otherwise passively steer signals in a desired direction. In some cases, a controller of the RIS may configure (e.g., adjust) the RIS to control the direction of reflection or refraction. A RIS controller may control multiple RISs, and in some cases, each RIS may be split into sub-RISs. Therefore, a network entity (e.g., a base station, a transmission and reception point (TRP), a network node, a transmitting UE) may transmit one or more messages towards a RIS and the RIS may redirect the one or more messages to a receiving device (e.g., a receiving UE), where the RIS controller may configure the RIS for communications between the network entity and the receiving UE. However, the RIS controller and/or the network entity may not have a way of identifying which RIS the network entity is transmitting to. Additionally, in some cases, the UE may be communicating with multiple TRPs in accordance with a multi-TRP configuration, where in some cases, one or more TRPs may communicate with the UE via one or more RISs. Accordingly, each TRP may use different RISs to communicate with the UE.

The techniques described herein allow a RIS controller to signal an indication of capabilities (e.g., a class) of the RIS controller to a network entity. In some cases, the capability indication may include capability information per RIS controller, or per RIS of the RIS controller. For instance, the RIS controller may signal a number of RIS elements of one or more of the RISs served by the RIS, a number of sub-RISs of the one or more RISs, a number of RISs served by the RIS controller, etc. Based on the capability, the network entity and the RIS controller may agree on one or more identifiers for each RIS (e.g., and/or each sub-RIS). Then, in communications between the UE and the network entity via the RIS, the network entity may signal to the RIS controller the RIS identifier being used for the communications.

In some implementations, prior to performing scheduled communications, a transmitting device, a RIS controller, one or more RISs, and a receiving device may participate in a training procedure to identify a communication configuration (e.g., beam configuration) between a transmitting device and a receiving device via a RIS. For example, a network entity may configure the reconfigurable surface to direct signals to a particular direction, for example, in the direction of the UE, such as via a RIS controller, where the base station may determine a direction for the reconfigurable surface to direct signals based on a reconfigurable surface training process. That is, the UE and the base station may exchange signals, using the reconfigurable surface, to determine a communication beam. In some examples, a transmitting device may transmit a sequence of training reference signals to the reconfigurable surface, where the reconfigurable surface may redirect the reference signals to a receiving device over a set of one or more beams (e.g., weights). For example, a RIS (and/or RIS controller) may generate a codebook with the particular weights and may reference the codebook when redirecting wireless signals. The weights, in the context of codebook-based beamforming, may be equivalently referred to as “precoders,” where the RIS may use a different codebook (or non-codebook) precoder for each training signal occasion. In such examples, the receiving device may measure the reference signals redirected from the reconfigurable surface and the receiving device and/or the transmitting device may determine a communication beam to use for future communications. For example, in future communications, the RIS controller may control the appropriate RIS to reflect an impinging beam from a network entity in accordance with the determined beam to reach the intended receiving device based on the training procedure.

In some cases, however, as a RIS controller may control multiple RIS, and the RIS controller may aid multiple network entities, such as in a mTRP operation, the training procedure and beam determination may become complicated. Accordingly, an association (e.g., mapping) may be determined for a network entity (e.g., transmitting devices) or a set of network entities with a communication scheme (e.g., time division multiplexing (TDM), frequency division multiplexing (FDM), spatial division multiplexing (SDM)) and an identifier (e.g., a communication scheme identifier, a TRP-Multiplex scheme ID). For example, a first identifier may be associated with a first network entity using a TDM communications scheme, a second identifier may indicate a first network entity using a FDM communications scheme, and similarly, another identifier may indicate training a first network entity and a second network entity jointly using TDM, etc. The RIS controller and the one or more network entities may be configured with the mapping.

Then, the one or more network entities may perform training procedures for each identifier to determine a communication configuration (e.g., beam configuration) for each identifier. For example, the one or more network entities (e.g., the first network and the second network entity) may transmit signals (e.g., references signals) to a RIS in accordance with configurations associated with each identifier. For example, the first network entity and the second network entity may both transmit signals to a RIS using TDM. The RIS may then reflect the signals over a set of one or more beams and the receiving device may measure parameters (e.g., reference signal received power (RSRP), reference signal received quality (RSRQ), signal to noise plus interference ratio (SINR)) associated with one or more beams received at the receiving device. The receiving device, the one or more network entities, or a combination thereof may select a preferred beam for that particular training procedure based on the measurements. In this way, a preferred beam may be selected for each identifier based on respective training procedures. Then, prior to communications between the UE and the network entity via a RIS, the network entity may signal to the RIS controller the RIS identifier and/or the communication scheme identifier associated with the communication so that the RIS controller may configure the appropriate RIS for the communications to reflect the preferred beam.

Particular aspects of the subject matter described herein may be implemented to realize one or more advantages. The described techniques may support improvements in utilizing RISs to extend coverage in a wireless communications system by improving training procedures and implementing procedures to allow for the deployment of multiple RISs such as in mTRP environments, among other advantages. As such, supported techniques may include improved network operations and, in some examples, may promote network efficiencies, among other benefits.

Aspects of the disclosure are initially described in the context of wireless communications systems. Aspects are then described with reference to communication schemes, a RIS, and a process flow. Aspects of the disclosure are further illustrated by and described with reference to apparatus diagrams, system diagrams, and flowcharts that relate to techniques for implementing RISs in multiple transmission and reception point (mTRP) communications.

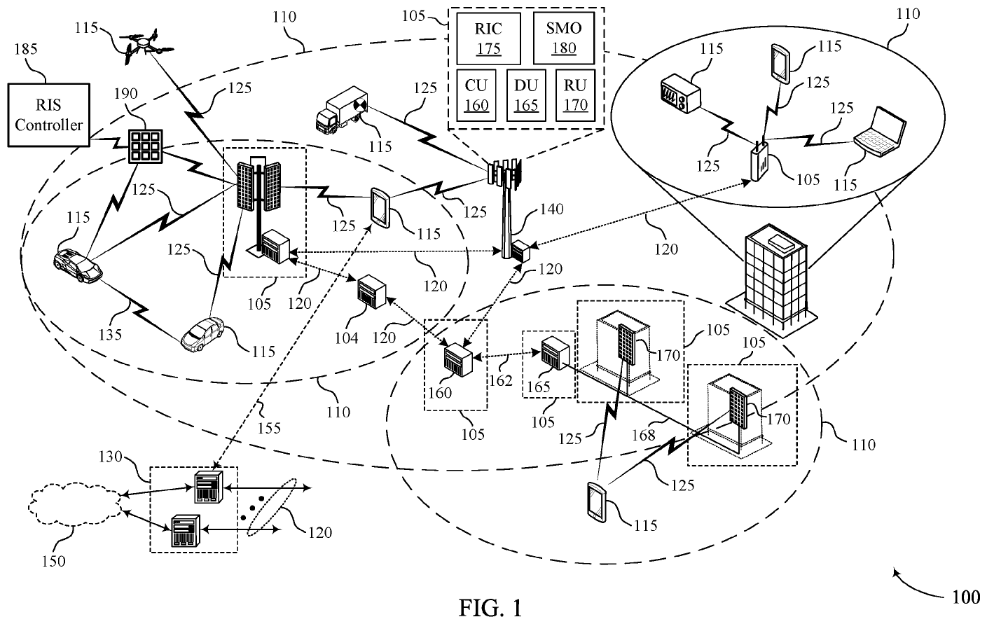

FIG. 1 illustrates an example of a wireless communications system 100 that supports techniques for implementing RISs in mTRP communications in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support techniques for implementing RISs in mTRP communications as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some cases, mTRP operations may be deployed to allow a UE 115 to communicate with multiple network entities 105. For multi-TRP and/or multi-panel transmissions, one or more scenarios may be implemented. For example, a single DCI scenario may be implemented in which a single PDCCH may be used for scheduling (e.g., such as ideal, small delay backhaul between network entities 105). A single codeword may be used but different spatial layers may be used across the different network entities 105. For example, one codework may maps to four layers, where layers 1 and 2 may be associated with a first network entity 105, and layers 3 and 4 may be associated with a second network entity 105. In another example, a multi-DCI scenario may be implemented in which multiple (e.g., two) PDCCHs may be used for scheduling (e.g., for both ideal and non-ideal backhaul). A first PDCCH may schedule a first codeword (e.g., transmitted from first network entity 105), and a second PDCCH may schedule a second codework (e.g., transmitted from a second network entity 105). The scheduling may result in overlapping, partially overlapping, or non-overlapping codewords in time resources, and/or frequency resources. Network entity 105 differentiation in the DCI may be implicit or explicit. For example, a field in the DCI (e.g., HARQ process ID) may be used to indicate if a grant corresponds to a first PDSCH (from the first network entity) or a second PDSCH (from the second network entity).

In some wireless communications systems, such as wireless communications system 100, where wireless communications system 100 may utilize multi-TRP deployments, a UE 115 may be in a location outside the coverage of any network entity 105, such as due to a blockage. A RIS 190 may be deployed to extend the coverage and improve reliability for the UE 115. To support the UE 115 in such multi-TRP deployments, a RIS controller 185 may identify and/or receive information regarding a serving network entity 105, one or more network entities 105 intending to communicate with the UE 115, a multi-TRP communication type (e.g., FDM, TDM, SDM), a RIS 190 being used, etc., in order to perform beam adjustment at the RIS 190 for the communications. In some cases, the RIS controller 185 may receive information associated with a network entity 105 (e.g., TRP) or set of network entities 105 that may be used, a type of communication (e.g., SDM, TDM, FDM), a RIS surface identifier (e.g., such as when there are multiple RIS surfaces controlled by same controlled, or when a RIS may be divided into sub-RISs, then each sub-RIS may be associated with an identifier). In some cases, a RIS controller 185 may be referred to as a network entity 105.

The techniques described herein allow a RIS controller 185 to transmit a first message indicating a class of at least a first RIS 190 of one or more RISs 190 served by the RIS controller 185. The class may be associated with one or more capabilities of the first RIS 190. In some cases, the first message may include capability information (e.g., a class) per RIS controller 185, or per RIS 190 of the RIS controller 185, such as the first RIS 190. For instance, the RIS controller 185 may signal a number of RIS elements of one or more RISs 190 served by the RIS controller 185, a number of sub-RISs of the one or more RISs 190, a number of RISs 190 served by the RIS controller 185, etc. The RIS controller 185 may receive a second message that includes an indication of one or more identifiers associated with the first RIS 190, where a quantity of the one or more identifiers may be associated with the first RIS 190 based on the class associated with the first RIS 190. The RIS controller 185 may receive a third message, such as from a network entity 105, indicating, via the one or more identifiers, a configuration for the first RIS 190 for communications between the first RIS 190 and one or more network entities 105.

In some cases, one or more network entities 105 may perform a training procedure with a RIS controller 185 to determine a configuration of a RIS 190 to aid communications between the network entity and receiving device (e.g., a UE 115). For example, a network entity 105 may (e.g., in downlink) or a UE 115 (e.g., in uplink) may sound a RIS 190 with multiplexed reference signals directed to a receiving device. The receiving device may then transmit an index representing a reference signal index selected by the receiving device. Using such information, the controller of the RIS and the transmitting device may determine precoding. In some cases, the training procedure and/or future communications (e.g., control communications, data communications) may be performed using one or more identifiers (e.g., the RIS identifiers), one or more communication scheme identifiers (e.g., TRP-Multiplex scheme ID), or a combination thereof as described herein. A RIS controller 205 may communicate with one or more network entities 105 via communication links 220 (e.g., OTA links, physical links), such as via communication links 220-a and 220-c. Additionally, a RIS controller 205 may communicate with one or more RISs 210 via communications link 220 (e.g., OTA links, physical links), such as via communication links 220-b and 220-d.

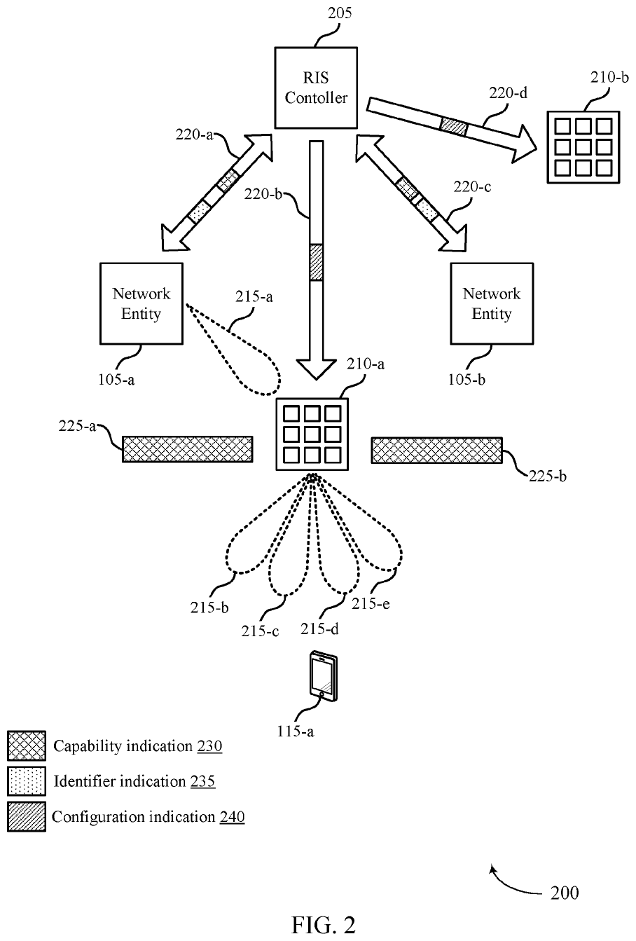

FIG. 2 illustrates an example of a wireless communications system 200 that supports techniques for implementing RISs in mTRP communications in accordance with one or more aspects of the present disclosure. The wireless communications system 200 may include network entities 105-a and 105-b, RIS controller 205, RISs 210-a and 210-b, and UE 115-a, which may be examples of network entities 105, RIS controllers, RISs, and UEs 115 as described with reference to FIG. 1. In some cases, network entity 105-a, network entity 105-b, or both may perform a training procedure with one or more RISs 210 supported by RIS controller 205. In some cases, network entities 105-a and/or 105-b may communicate with UE 115-b via one or more RISs 210 based on the respective training procedures, based on one or more identifiers associated with RIS controller 205, or a combination thereof. Additionally, or alternatively, other wireless devices, such as UE 115-a may implement a training procedure with RIS controller 205, and/or communicate with network entities 105-a and/or 105-b based on respective training procedures, based on one or more identifiers associated with RIS controller 205, or a combination thereof.

A network entity 105 may serve multiple UEs 115 and in some examples, a network entity 105 may transmit information to one or more UEs 115 using beamformed communications (e.g., messages sent using beams). In some examples, physical proximity, environmental factors (e.g., interference from other devices, blockages 225 due to obstructions), or power constraints may impair beamformed communications between a network entity 105 and a UE 115. In some examples, a network entity 105 a may be unable to successfully transmit information to a UE 115 via an LOS path. For example, network entity 105-a may be unable to transmit information directly to UEs 115-a via an LOS path, for example, due to interference from one or more other devices, due to a power constraint at network entity 105-a, due to a blockage 225 (e.g., an obstruction such as a building, tree, vehicle, mountain), due to a physical distance between network entity 105-a and UE 115-a, or due to any other factors affecting signal quality between network entity 105-a and the UE 115.

To overcome such impairments, the network entity 105 may employ an active antenna unit (AAU) to act as a relay between the network entity 105 and the UE 115. The AAU may include one or more antenna ports, radio frequency (RF) chains, and power amplifiers. The AAU may allow the network entity 105 to increase spatial diversity, beamforming gain, and cell coverage. For example, the AAU may receive a beamformed communication from the network entity 105, amplify the beamformed communication, and re-transmit the beamformed communication to a UE 115. As such, in comparison to receiving the beamformed communication directly from network entity 105, the UE 115 may have a higher likelihood of successfully receiving the beamformed communication via the AAU. However, active components (e.g., RF chains, power amplifiers) used by the AAU to amplify signals may be associated with increased power consumption. For example, a power amplifier at the AAU may utilize significant power overhead to amplify and re-transmit a received signal. Such power overhead may be undesirable and inefficient in some systems.

In some examples, the network entity 105 (e.g., or some other transmitting device such as a controlling UE) may employ a relaying device that uses passive components (e.g., capacitors, resistors) to reflect incoming signals in one or more directions with a reduced power overhead. In some cases, a relaying device may be a RIS 210, a repeater, a low-power UE 115, etc. For example, a RIS 210 (e.g., a near passive device) may use a capacitor and a resistor to reflect a signal in a specific direction (e.g., instead of using a power amplifier to amplify and re-transmit the signal). As such, the RIS 210 may increase cell coverage, spatial diversity, and beamforming gain while consuming less power than an AAU. For example, a RIS 210 may use a relatively low power to redirect signals from a transmitting device to a receiving device. In some cases, the RIS 210 may reflect or refract an impinging wave to a desired direction. For example, the RIS 210 may redirect a signal from the UE 115 to the network entity 105 by reflecting the signal, for example, around blockage 225 (e.g., blockage 225-a, blockage 225-b), or vice versa.

In some aspects, the network entity 105 and/or a RIS controller 205 may dynamically configure the RIS 210 to reflect an incoming signal in a specific direction. For example, the network entity 105 and/or a RIS controller 205 may configure the RIS 210 to reflect a beamformed communication in a direction of a UE 115 based on a location of the UE 115. Similarly, the UE 115 may transmit a beamformed communication in a direction of the RIS 210 based on a network entity 105 configuration or a UE 115 selection. Accordingly, a reflection direction may be controlled by the network entity 105 and/or a RIS controller 205. For example, the network entity 105 and/or a RIS controller 205 may configure the RIS 210 to direct signals to a particular direction determined by the network entity 105. The appropriate reflection direction to be implemented by a RIS 210 for directing a signal to an intended receiver may be determined by a training procedure.

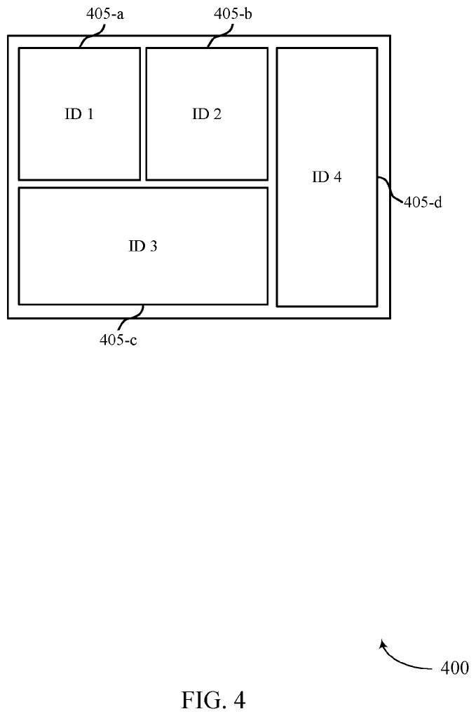

In some cases, a RIS controller 205 may control multiple RISs 210, and in some cases, each RIS 210 may be split into sub-RISs (e.g., clusters), as described in more detail with reference to FIG. 4. A network entity 105 may use a particular RIS 210 and/or sub-RIS to aid in communications with a receiving device (e.g., a UE 115). Accordingly, in order to configure the RIS 210 to appropriately reflect a beam in the direction of the intended receiver, the RIS controller 205 may need to know which RIS 210 the network entity 105 is transmitting towards. Additionally, in some cases, the UE 115 may be communicating with multiple network entities 105, such as in accordance with a multi-TRP configuration, where in some cases, one or more network entities 105 may communicate with the UE 115 via one or more RISs 210. Accordingly, each network entity 105 may use different RISs 210 to communicate with the UE 115. However, the RIS controller 205 and/or the network entity 105 may not have a way of identifying which RIS 210 the network entity 105 is transmitting to.

To identify the RISs 210 and/or sub-RISs being used by a transmitting device to reach a receiving device, the transmitting device and/or the RIS controller 205 may assign identifiers to each RIS 210 and/or sub-RIS. In some cases, the identifiers assigned to each RIS 210 and/or sub-RIS may be based on capabilities of the RIS controller 205 and/or capabilities of each RIS/sub-RIS served by the RIS controller 205. In some cases, a RIS controller 205 may transmit, to one or more network entities 105, an indication of capabilities (e.g., capabilities indication 230, a class associated with the RIS controller) of the RIS controller 205. In some cases, the capability indication 230 may include capability information (e.g., a class) per RIS controller 205, or per RIS 210 of the RIS controller 205.

The capability indication 230 may include information associated with each RIS and/or sub-RIS served by the RIS controller 205. In another example, the capability indication 230 may include information associated with particular one or more RISs and/or sub-RISs served by the RIS controller 205. In some cases, the capability indication 230 may include a number of RIS elements of one or more of the RISs 210 served by the RIS controller 205, a number of sub-RISs of the one or more RISs 210, a number of RIS elements of one or more of the sub-RISs, a number of RISs 210 served by the RIS controller 205, or a combination thereof. Additionally, or alternatively, the capability indication 230 may include one or more non-codebook and/or codebook beams (e.g., DFT based beams, sequence based beams, golden beams) that a RIS 210 may use on the surface of the RIS 210, a duration of time (e.g., a time switch) associated with changing beams (e.g., changing RIS configurations) from one beam to another on a RIS 210, a granularity of the weights of RIS elements (e.g., complex weights within a range, phase only codebook, phase and amplitude, etc.), or a combination thereof. Additionally, or alternatively, the capability indication 230 may include an indication of whether a RIS 210 may change beams across frequencies, a bandwidth size across which the RIS 210 may change beams (e.g., a RIS 210 may be capable of changing beams every X resource blocks, or frequencies units), or a combination thereof. Additionally, or alternatively, the capability indication 230 may include an indication of whether a RIS 210 has a Uu only modem, sidelink only modem, other OTA modems, etc.

Based on the capability indication 230, the network entity 105 and the RIS controller 205 may agree on one or more identifiers for each RIS 210 and/or sub-RIS. For example, network entity 105-a may transmit (e.g., via communication link 220-a, such as an OTA link, a physical link, etc.) an identifier indication message to the RIS controller 205 including on or more RIS identifiers, sub-RIS identifiers, or a combination thereof. The identifiers may represent names the network entity 105 assigned to one or more of the RISs 210 and/or sub-RISs served by the RIS controller 205. Then, in communications between the UE 115 and the network entity 105 via a RIS 210, the network entity 105 may signal to the RIS controller 205 the RIS identifier of the RIS 210 being used for the communications. The RIS controller 205 may then configure the indicated RIS 210 accordingly for the communications.

For example, the RIS controller 205 may control at least RIS 210-a and RIS 210-b and based on the capability indication 230, network entity 105-a may assign RIS 210-a with a first identifier and assign RIS 210-b with a second identifier. Network entity 105-a may transmit the identifier indication 235 to the RIS controller 205 including the assigned identifiers. Then prior to or upon transmitting a beam toward RIS 210-a intended to be relayed to UE 115-a, network entity 105-a may transmit an indication that network entity 105-a will use RIS 210-a for the communications such as by indicating the first identifier to the RIS controller 205. The RIS controller 205 may identify the RIS 210 associated with the first identifier and then configure the RIS 210 appropriately so that the RIS 210 reflects the beams from network entity 105-a to UE 115-a. In some cases, to configure the RIS 210, the RIS controller 205 may signal the RIS 210 with the configuration (e.g., configuration indication 240) such as via a communication link 220-b (e.g., an OTA link, a physical link). Any number of network entities 105 may perform a same or similar procedure with RIS controller 205. For example, network entity 105-b may perform a same or similar procedure as network entity 105-a. In some cases, different network entities 105 may assign the same RIS 210 with the same or different identifiers. Accordingly, in some cases, the RIS controller 205 may store different sets of identifiers, where each set is associated with a particular network entity 105.

In some cases, RIS training may be performed such as to determine which RIS 210 to be used and/or how to configure a RIS 210 to aid communications between devices. That is, wireless devices may exchange signals, using the RIS 210, to determine a communication beam 215. In some examples, a transmitting device may transmit a sequence of training reference sequences towards the RIS 210, where the RIS 210 may redirect the reference sequences to a receiving device. For example, the network entity 105-a may transmit a sequence of reference signals towards the RIS 210 (e.g., via beam 215-a) and the RIS 210 may redirect one or more of the reference signals to UE 115-a (e.g., via one or more of beams 215-b, 215-c, 215-d, and 215-e). In such examples, UE 115-a may measure the reference signals redirected from the RIS 210 and may determine a communication beam 215 to use to communicate with network entity 105-a (e.g., a best beam, a preferred beam). The UE 115-a may select the index (e.g., associated with communication beam 215) with a highest receiver metric, such as spectral efficiency, RSRP, RSRQ, SINR, among other receiver metrics. UE 115-a may transmit an indication to network entity 105-a, such as via the RIS 210, of the determined communication beam. In some cases, UE 115-a may transmit an indication of the one or more measurements to network entity 105-a and the network entity may determine the communication beam 215.

In some cases, the RIS 210 may redirect signals with particular weights applied to one or more elements. That is, the RIS 210 may use the elements to redirect signals and the RIS 210 may redirect the signals using particular weights. The weights may be phase shifters, magnitude shifters, panel angle shifters, among other weights associated with redirecting wireless signals. In some cases, the RIS 210 may generate a codebook with the particular weights and may reference the codebook when redirecting wireless signals. The weights, in the context of codebook-based beamforming, may be equivalently referred to as “precoders,” where the RIS 210 may use a different codebook (or non-codebook) precoder for each training signal occasion (e.g., training reference sequences). Various wireless communications systems may use the techniques as described herein. For example, such ideas may be applicable to Uu links, sidelink (e.g., PC5 interface), among other wireless communications links. In communications systems supporting sidelink communications, the functions performed by the network entity 105-a may be performed by a sidelink device such as a monitoring UE 115.

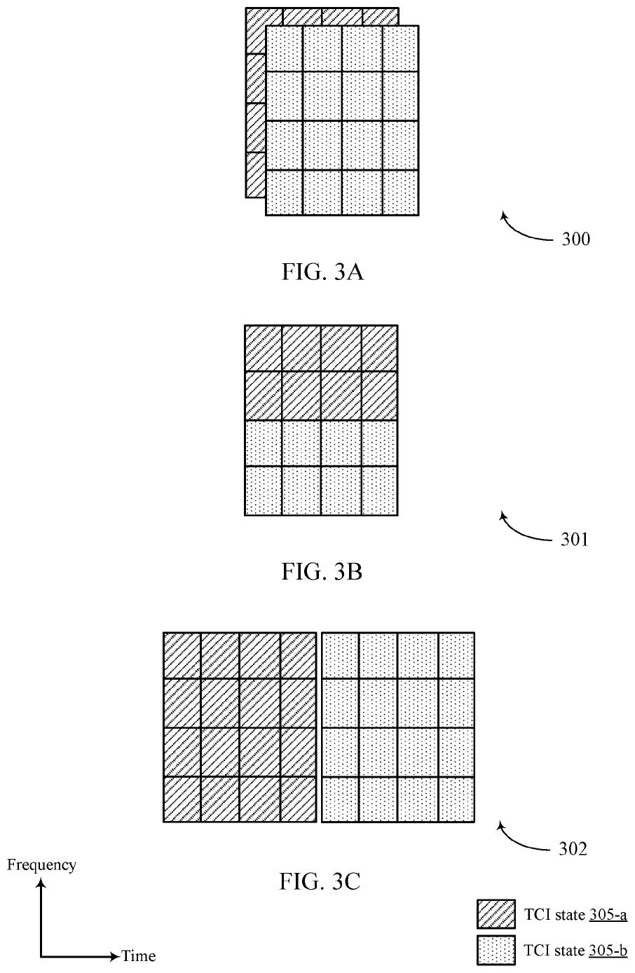

In some cases, a network entity 105-a may perform a training procedure with multiple RISs 210, such as RISs 210 near UE 115-a, near network entity 105-a, or a combination thereof. Network entity 105-a may perform the training procedure with multiple RISs 210 to determine a communication beam for each RIS 210 to serve UE 115-a. In some cases, network entity 105-a may determine which RIS 210 to use to reach UE 115-a based on the training procedures performed across the RISs 210. Additionally, in some cases, such as in mTRP operations, UE 115-a may be communicating and/or participating in multiple training procedures with different transmitting devices, different RISs 210, etc. As described in more detail with reference to FIGS. 3A through 3C, the transmitting devices may be configured to communicate with UE 115-a in accordance with a communication scheme, such as TDM, FDM, or SDM.

The techniques described herein support a training procedure that may include associating (e.g., mapping) a network entity 105 (e.g., transmitting devices) or a set of network entities 105 and a communication scheme with an identifier (e.g., a RIS identifier, a TRP-Multiplex scheme ID) in order to determine a beam for communications between a network entity 105 and a UE 115 in light of communications with other network entities 105, via other RISs 210, etc. In some cases, the mapping may be based on the network entities 105 using the same RIS 210 to communicate with UE 115-a. For example, a first identifier (e.g., ID1) may be associated with training a first network entity 105 (e.g., network entity 105-a) using a TDM communications scheme, a second identifier (e.g., ID2) may indicate training the first network entity 105 using an FDM communications scheme, and a third identifier (e.g., ID3) may indicate training the first network entity 105 using an SDM communications scheme. Additionally, or alternatively, a fourth first identifier (e.g., ID4) may be associated with training a second network entity 105 (e.g., network entity 105-b) using a TDM communications scheme, a fifth identifier (e.g., ID5) may indicate training the second network entity 105 using an FDM communications scheme, and a sixth identifier (e.g., ID6) may indicate training the second network entity 105 using an SDM communications scheme. Additionally, or alternatively, a seventh identifier (e.g., ID7) may be associated with training the first network entity 105 and the second network entity 105 using a TDM communications scheme, an eight identifier (e.g., ID8) may indicate training the first network entity 105 and the second network entity 105 using an FDM communications scheme, and a ninth identifier (e.g., ID9) may indicate training the first network entity 105 and the second network entity 105 using an SDM communications scheme. The network entities 105, the RIS controller 205, or a combination thereof may be configured with the mapping.

In some cases, a network entity 105 may determine the identifiers and mapping. In some cases, the network entity 105 may be preconfigured or receive an indication of the identifiers or mapping. For example, a network entity 105 may serve at least network entities 105-a and 105-b and accordingly may determine the identifiers and mapping for the network entities. The serving network entity 105 may transmit a signal including the identifiers and mapping to the network entities 105 involved in the mappings. In some cases, a RIS controller 205 may determine the identifiers and mapping and transmit a signal including the identifiers and mapping to the network entities 105 involved. In some implementations, instead of signaling the communication identifier, the network entity 105 may indicate to the RIS controller 205 the network entity indices (e.g., the first network entity, the second network entity) as well as the communication scheme and/or type (e.g., FDM, SDM, TDM). Then the RIS controller 205 may update its database with a beamformer and/or configuration on the desired RIS 210.

Upon being configured with the communication scheme identifiers, one or more network entities 105 (e.g., the first network and the second network entity) may transmit signals (e.g., references signals) to a RIS 210 in accordance with configurations associated with each identifier. For example, the first network entity 105 and the second network entity 105 may both perform training procedures in accordance with the mapping. In some cases, the training procedures may be performed in sequential order. For example, the first network entity 105 may perform the training procedure associated with ID1 for a number of occasions and/or reference signals (e.g., M1 occasions), then may perform the training procedure associated with ID2 for a number of occasions and/or reference signals (e.g., M2 occasions), and so on. The second network entity 105 may similarly perform the training procedures associated with IDs four through six. Then, both network entities 105 may perform the training procedures in accordance with IDs seven through nine. UE 115-a, the one or more network entities 105, or a combination thereof may select a preferred beam for each training procedure based on one or more measurements. Accordingly, the receiving device, the transmitting device, the RIS controller 205, or a combination therefore may select a beam 215 (e.g., a best beam 215, a preferred beam 215) for each communication identifier based on the training. For example, with reference to ID7, a single beam 215 may be selected when UE 115-a is configured to receive signals from the first and second network entities 105 in accordance with TDM. In some cases, the RIS controller 205 may determine or receive an indication of the beam 215 to be associated with that communication identifier based on the training procedure. Accordingly, the RIS controller 205 may store a beam 215 for each communication identifier to configure for future communications associated with a respective communication identifier.

While the example described herein considers nine identifiers with two network entities 105, it should be understood that the number of identifiers and mapping may be based on the communication environment, such as a number of network entities 105 communicating the UE 115-a, a number of RISs 210 near UE 115-a, a communication scheme supported by UE 115-a, the network entities 105, etc. Accordingly, a network entity 105 and/or RIS controller 205 may determine or be configured with any number of communication scheme identifiers associated with any number of network entities 105, communication schemes, etc. In some implementations, UE 115-a may be configured with the communication scheme identifiers and mapping. UE 115-a may use the same or different beamformers and filters at UE 115-a. Accordingly, UE 115-a may use the identifier to adjust the beams of UE 115-a (e.g., QCL-D).

Therefore, the techniques described herein allow for devices to identify RISs 210 and/or sub-RISs with a RIS identifier and allow for beams to be selected for a particular communication type (e.g., for a certain network entity 105 using a particular communication scheme). It may be beneficial for the RIS controller 205 to know the network entities 205 that the RIS controller 205 is to aid and the transmission scheme (e.g., SDM, FDM, TDM) so that the configuration and/or beamformer is set accordingly. The configuration of a RIS 210 may be adjusted accordingly prior to the communications. The indication of the identifiers may help in determining such RIS beamformer on the surface (e.g., RIS configuration). Accordingly, a network device 105 may determine which RIS 210 to use to communicate with UE 115-a and accordingly, the identifier associated with the RIS 210, where the determination may be based on one or more training procedures. Then, in preparing for communications between the UE 115 and the network entity 105 via the determined RIS 210 (e.g., downlink communications, uplink communications, sidelink communications), the network entity 105 may signal to the RIS controller 205, the RIS identifier of the RIS 210 being used for the communications. Additionally, or alternatively, the network entity 105 may signal a communication scheme identifier (e.g., TRP-Multiplex scheme ID), where a preferred beam is associated with each communication scheme identifier. Therefore, the RIS controller 205 may configure the appropriate RIS 210 for the communications based on the RIS identifier, the communication scheme identifier, or both.

For example, during training, beam 215-d from RIS 210-a may have been determined to be the preferred beam for communication scheme ID2. Accordingly, prior to communicating with UE 115-a via RIS 210-a, network entity 105-a may signal to RIS controller 205 that network entity 105-a is scheduling communications in accordance with communication scheme ID2, and may indicate the RIS identifier associated with RIS 210-a. RIS controller 205 may identify (e.g., based on stored information) that beam 215-d is the preferred beam for communication scheme ID2 between network entity 105-a and UE 115-a via RIS 210-a (e.g., configuration indication 240). Accordingly, RIS controller 205 may then configure RIS 210-a to reflect an impinging beam from network entity 105-a to achieve beam 215-d. In some implementations, the network entity 105 may include the RIS identifier, the communication scheme identifier, or both in a control message (e.g., an RRC message, a DCI message, a MAC-CE message). In some cases, the network entity 105 may include the RIS identifier, the communication scheme identifier, or both in a TCI indication, a QCL indication, or both, such as in a DCI message. The RIS identifier, the communication scheme identifier, or both may be included in fields dedicated to the respective identifiers, or be included in existing fields of the control message.

In some implementations, a network entity 105 may transmit the control message including the or more identifiers directly to the RIS controller 205 or the RIS controller 205 may monitor the DCI sent to UEs 115. For example, the network entity 105 may transmit a group common control message (e.g., a group common DCI), where the group common control message may be intended for one or more UEs 115, the RIS controller 205, or both. In either case, the control message may inform the RIS controller 205 on the time allocation (e.g., time resources), frequency allocation (e.g., frequency resources) of the transmission the RIS controller 205 is to aid. In some cases, the UE may receive the control message and use the information (e.g., information associated with QCL) to adjust a filter of the UE 115 based on one or more identifiers included in the control message. QCL type D may be used because it is related to filtration and/or beamformer at the UE 115, and the UE 115 may adjust the filter it uses on each of these training set based on received one or more identifier.

FIGS. 3A, 3B, and 3C illustrate examples of communications schemes 300, 301, and 302, respectively that support techniques for implementing RISs in mTRP communications in accordance with one or more aspects of the present disclosure. The communication schemes 300, 301, and 302 may be implemented in mTRP communications and may be implemented by a one or more network entities, and/or one or more UEs 115, which may be examples of network entities 105, and UEs 115 as described with reference to FIGS. 1 and 2. The communication schemes 300, 301, and 302 may be depicted with reference to an axis, in which time is depicted on the x-axis, and frequency is depicted on the y-axis. In some cases, time may refer to time units, such as symbols, and frequency may refer to frequency units such as resource blocks.

FIG. 3A may represent an SDM communication scheme. SDM may refer to a technique in which physical separation of transmitting antennas may be used to deliver simultaneously different data streams. In some cases, SDM may utilize a single codework, and/or a single redundancy version. In some cases, SDM may utilize DMRS ports on different CDM groups, and/or may utilize/result in PTRS enhancements. FIG. 3B may represent an FDM communication scheme. FDM may refer to a technique in which multiple data signals are combined for simultaneous transmission via a shared communication frequency. In some cases, FDM may utilize a single codework, and/or a single redundancy version. In some cases, FDM may utilize and/or result in FDRA enhancements, and/or may utilize/result in PTRS enhancements. FIG. 3C may represent an TDM communication scheme. TDM may refer to a technique by which multiple data signals may be transmitted over a common communication channel in different time resources. In some cases, TDM may utilize slot and/or mini-slot repetition, utilize TCI states and/or redundancy version patterns across repetitions, utilize dynamic indication for a number of repetitions, or a combination thereof.

To achieve the mTRP communications as described herein, one of a TDM, FDM, or SDM communication scheme may be deployed. For example, a first network entity and a second network entity may be communicating with a UE in accordance one of TDM, FDM, or SDM to achieve mTRP operations. The first TRP may be associated with TCI state 305-a and the second network entity may be associated with TCI state 305-b.

As described with reference to FIG. 2, a RIS may be utilized to extend coverage in some wireless communications systems, such as a wireless communications system that supports mTRP deployment. A RIS controller may configure a RIS to aid in the communications. In some cases, the communication scheme (e.g., FDM, TDM, SDM) being used for mTRP communications may impact preferred beams, RIS configurations, etc. For example, a RIS may be unable to separate frequencies, such as if the RIS receives signals from multiple different network entities in accordance with FDM. Therefore, for each communication type, the RIS controller may implement a different beam configuration for the RIS that is aiding a communication. To do so, the RIS controller may receive and/or identify information associated with the communications the RIS controller is to aid. The information may indicate a serving network entity 105, and/or one or more network entities 105 intending to communicate with the UE 115, a UE 115 identifier, a multi-TRP communication type such as FDM, TDM, or SDM (e.g., via a communication scheme identifier), a RIS being used (e.g., via one or more RIS identifiers), etc. The RIS controller may then configure the RIS accordingly based on the received information.

FIG. 4 illustrates an example of a RIS 400 that supports techniques for implementing RISs in mTRP communications in accordance with one or more aspects of the present disclosure. The RIS 400 may include any number of sub-RISs, clusters, etc. and may be used by one or more network entities, and/or one or more UEs 115, which may be examples of network entities 105, and UEs 115 as described with reference to FIGS. 1 through 3C. Additionally, the RIS 400 may be controlled by a RIS controller, which may be an example of a RIS controller as described with reference to FIGS. 1 through 3C.

In some cases, a RIS controller 205 may control multiple RISs 210, and in some cases, each RIS 210 may be split into sub-RISs 405 (e.g., clusters), where each sub-RIS 405 may include a set of one or more RIS elements. In some cases, each sub-RIS 405 may serve (e.g., be associated with) a particular subband, a particular UE or set of UEs.

As described herein, a network entity may use a particular RIS 400 and/or sub-RIS 405 to aid in communications with a receiving device (e.g., a UE). Accordingly, in order to configure the RIS 400 to appropriately reflect a beam in the direction of the intended receiver, a RIS controller may need to know which RIS 400 the network entity is transmitting towards. To identify the RIS 400 and/or sub-RISs 405 being used by a transmitting device to reach a receiving device, the transmitting device and/or the RIS controller may assign identifiers to each RIS 400 and/or sub-RIS 405. In some cases, the network entity 105 and/or the RIS controller may agree on one or more identifiers for each RIS 400 and/or sub-RIS 405 based on a capability indication transmitted from the RIS controller to the network entity. For example, RIS 400 may be assigned a RIS identifier, and sub-RIS 405-a may be assigned a first sub-RIS identifier (e.g., ID1. Similarly, sub-RIS 405-b may be assigned ID 2, sub-RIS 405-c may be assigned ID 3, and sub-RIS 405-d may be assigned ID 4. Then, prior to communications with a UE, the network entity may signal, to the RIS controller, the RIS identifier and/or the sub-RIS identifier to be used to aid in the communications. The RIS controller may then configure the RIS 400 and/or the sub-RIS 405 appropriately to aid the communications, such as to configure the RIS 400 and/or sub-RIS 405 to reflect an impinging beam from the network entity toward the receiving UE.

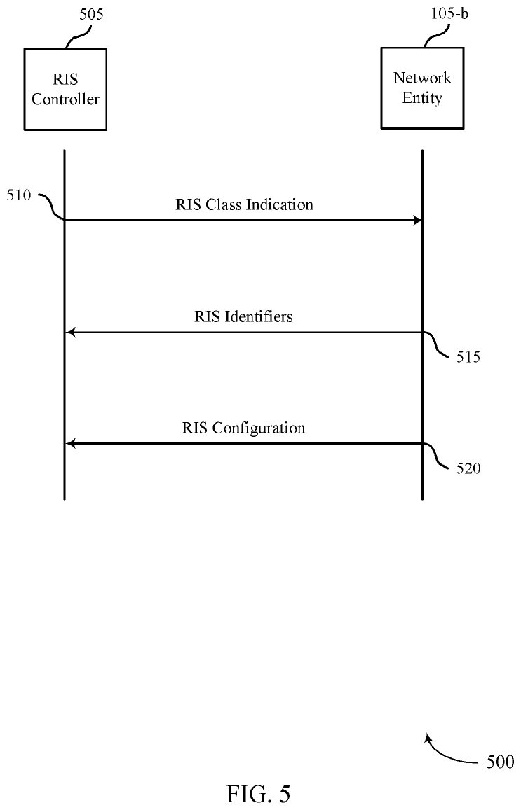

FIG. 5 illustrates an example of a process flow 500 that supports techniques for implementing RISs in mTRP communications in accordance with one or more aspects of the present disclosure. The process flow 500 may illustrate an example RIS implementation procedure. For example, RIS controller 505 may transmit RIS capability information to network entity 105-b, and RIS controller 505 and network entity 105-b (e.g., a TRP) may determine a configuration associated with RIS controller 505 based on the capability information. Network entity 105-b and RIS controller 505 may be examples of the corresponding wireless devices described with reference to FIGS. 1 through 4. In some cases, instead of network entity 105-b participating in the RIS implementation procedure, a different type of wireless device (e.g., a UE 115) may perform a same or similar procedure. Alternative examples of the following may be implemented, where some steps are performed in a different order than described or are not performed at all. In some cases, steps may include additional features not mentioned below, or further steps may be added.

At 510, RIS controller 505 may transmit a first message indicating a class of a first RIS of one or more RISs served by RIS controller 505. The class may be associated with one or more capabilities of the first RIS. The first RIS may be associated with a set of frequency resources, one or more UEs, or a combination thereof. The first RIS may include one or more sub-RISs. Each sub-RIS may be associated with a set of frequency resources, one or more UEs, or a combination thereof.

In some cases, transmitting the first message may include transmitting the first message indicating a number of RIS elements of the first RIS. In some cases, transmitting the first message may include transmitting the first message indicating a number of sub-RISs supported by the first RIS. In some cases, transmitting the first message may include transmitting the first message indicating a number of RIS elements the first RIS supports per sub-RIS. In some cases, transmitting the first message may include transmitting the first message indicating one or more codebook-based or non-codebook based beams supported by the first RIS. In some cases, transmitting the first message may include transmitting the first message indicating a duration of time in which the first RIS is capable of switching between configurations of the first RIS. In some cases, transmitting the first message may include transmitting the first message indicating a granularity of weights associated with RIS elements of the first RIS. In some cases, transmitting the first message may include transmitting the first message indicating whether the first RIS is capable of switching configurations across frequencies. In some cases, transmitting the first message may include transmitting the first message indicating a bandwidth size over which the first RIS is capable of switching configurations. In some cases, transmitting the first message may include transmitting the first message indicating one or more modem types the first RIS is configured with.

At 515, RIS controller 505 may receive a second message that includes an indication of one or more identifiers associated with the first RIS, where a quantity of the one or more identifiers may be associated with the first RIS based on the class associated with the first RIS.

At 520, RIS controller 505 may receive a third message indicating, via the one or more identifiers, a configuration for the first RIS for communications between the first RIS and one or more network entities 105. Receiving the third message may include receiving a downlink control information message including the third message.

In some cases, receiving the third message may include receiving the third message indicating a communication scheme identifier, where the communication scheme identifier may be indicative of the configuration for the first RIS for the communications between the first RIS and the one or more network entities 105. The communication scheme identifier may be included in a transmission configuration indicator state indication, a quasi-colocation indication, or both. The quasi-colocation indication may be associated with quasi-colocation type D.

In some cases, the configuration for the first RIS indicated via the one or more identifiers may be included in a transmission configuration indicator state indication, a quasi-colocation indication, or both. The quasi-colocation indication may be associated with quasi-colocation type D.

In some implementations, RIS controller 505 may receive a signal indicating a set of one or more communication scheme identifiers, where each communication scheme identifier may be associated with a set of one or more network entities and a communication type. The communication type may be one of spatial division multiplexing, frequency division multiplexing, or time division multiplexing. RIS controller 505 may receive a trigger to perform a training procedure, where the trigger may include a communication scheme identifier from the set of one or more communication scheme identifiers, a set of network entities 105 involved in the training procedure, the communication type associated with the training procedure, a RIS identifier to be used for the training procedure, or a combination thereof. RIS controller 505 may perform the training procedure in accordance with the trigger to determine one or more preferred RIS beams associated with the training procedure.

RIS controller 505 may receive a signal indicating one or more parameters associated with the communications between the first RIS and the one or more network entities 105. The one or more parameters may include allocated resources, the one or more network entities, a communication type, or a combination thereof for the communications between the first RIS and the one or more network entities 105. The signal may be received with the third message, or separate from the third message. The signal may be included in a downlink control information message intended for the RIS controller, or included in a group-common downlink control information message.

RIS controller 505 may adjust the configuration of the first RIS in accordance with the configuration indicated in the third message. The communications between the first RIS and the one or more network entities may include downlink communications, uplink communications, or a combination thereof.

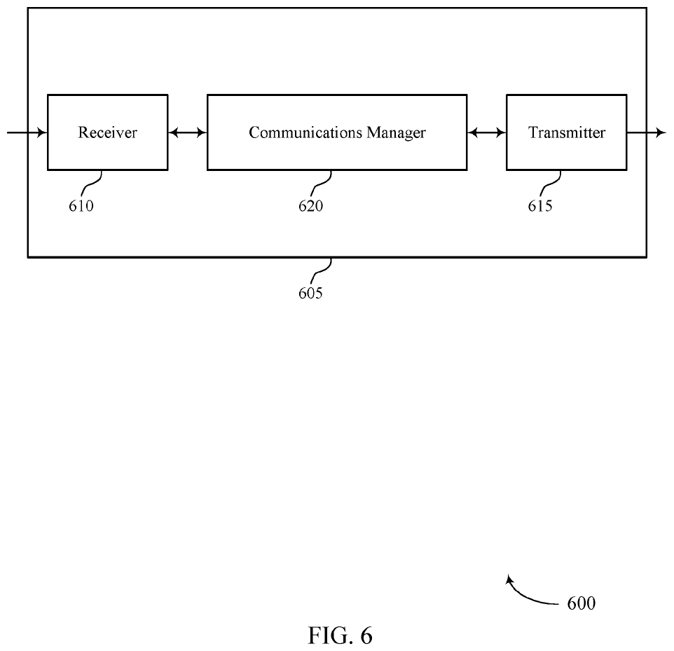

FIG. 6 shows a block diagram 600 of a device 605 that supports techniques for implementing RISs in mTRP communications in accordance with one or more aspects of the present disclosure. The device 605 may be an example of aspects of a network entity 105 as described herein. The device 605 may include a receiver 610, a transmitter 615, and a communications manager 620. The device 605 may also include a processor. Each of these components may be in communication with one another (e.g., via one or more buses).

The receiver 610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 605. In some examples, the receiver 610 may support obtaining information by receiving signals via one or more antennas. Additionally, or alternatively, the receiver 610 may support obtaining information by receiving signals via one or more wired (e.g., electrical, fiber optic) interfaces, wireless interfaces, or any combination thereof.

The transmitter 615 may provide a means for outputting (e.g., transmitting, providing, conveying, sending) information generated by other components of the device 605. For example, the transmitter 615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 615 may support outputting information by transmitting signals via one or more antennas. Additionally, or alternatively, the transmitter 615 may support outputting information by transmitting signals via one or more wired (e.g., electrical, fiber optic) interfaces, wireless interfaces, or any combination thereof. In some examples, the transmitter 615 and the receiver 610 may be co-located in a transceiver, which may include or be coupled with a modem.

The communications manager 620, the receiver 610, the transmitter 615, or various combinations thereof or various components thereof may be examples of means for performing various aspects of techniques for implementing RISs in mTRP communications as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a RIS controller in accordance with examples as disclosed herein. For example, the communications manager 620 may be configured as or otherwise support a means for transmitting a first message indicating a class of a first RIS of one or more RISs served by the RIS controller, the class associated with one or more capabilities of the first RIS. The communications manager 620 may be configured as or otherwise support a means for receiving a second message that includes an indication of one or more identifiers associated with the first RIS, a quantity of the one or more identifiers associated with the first RIS based on the class associated with the first RIS. The communications manager 620 may be configured as or otherwise support a means for receiving a third message indicating, via the one or more identifiers, a configuration for the first RIS for communications between the first RIS and one or more network entities.

Additionally, or alternatively, the communications manager 620 may support wireless communications at a network entity in accordance with examples as disclosed herein. For example, the communications manager 620 may be configured as or otherwise support a means for receiving a first message indicating a class of a first RIS of one or more RISs served by a RIS controller, the class associated with one or more capabilities of the first RIS. The communications manager 620 may be configured as or otherwise support a means for transmitting a second message that includes an indication of one or more identifiers associated with the first RIS, a quantity of the one or more identifiers associated with the first RIS based on the class associated with the first RIS. The communications manager 620 may be configured as or otherwise support a means for transmitting a third message indicating, via the one or more identifiers, a configuration for the first RIS for communications between the first RIS and one or more network entities.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for more efficient utilization of communication resources.

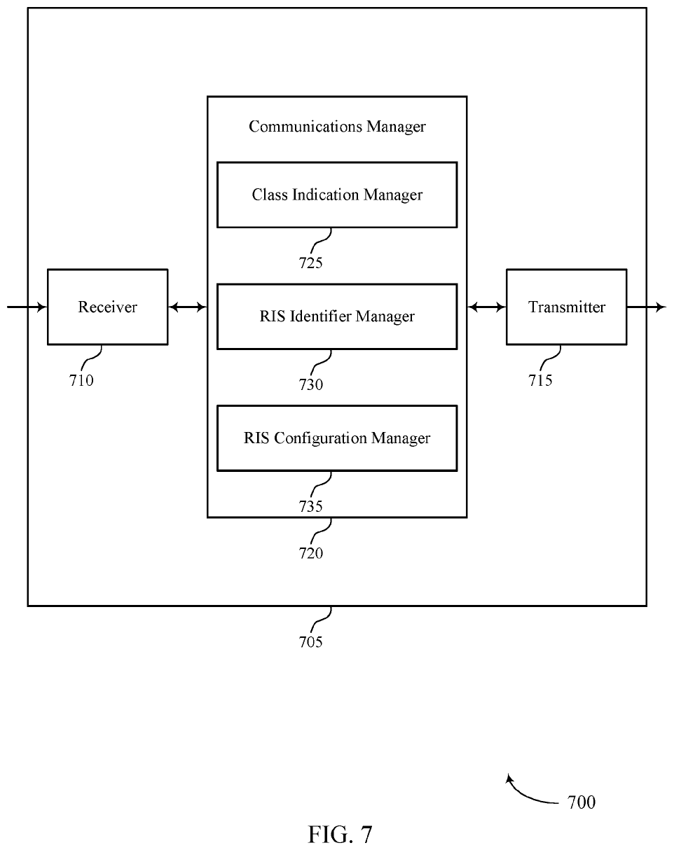

FIG. 7 shows a block diagram 700 of a device 705 that supports techniques for implementing RISs in mTRP communications in accordance with one or more aspects of the present disclosure. The device 705 may be an example of aspects of a device 605 or a network entity 105 as described herein. The device 705 may include a receiver 710, a transmitter 715, and a communications manager 720. The device 705 may also include a processor. Each of these components may be in communication with one another (e.g., via one or more buses).

The receiver 710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 705. In some examples, the receiver 710 may support obtaining information by receiving signals via one or more antennas. Additionally, or alternatively, the receiver 710 may support obtaining information by receiving signals via one or more wired (e.g., electrical, fiber optic) interfaces, wireless interfaces, or any combination thereof.

The transmitter 715 may provide a means for outputting (e.g., transmitting, providing, conveying, sending) information generated by other components of the device 705. For example, the transmitter 715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 715 may support outputting information by transmitting signals via one or more antennas. Additionally, or alternatively, the transmitter 715 may support outputting information by transmitting signals via one or more wired (e.g., electrical, fiber optic) interfaces, wireless interfaces, or any combination thereof. In some examples, the transmitter 715 and the receiver 710 may be co-located in a transceiver, which may include or be coupled with a modem.

The device 705, or various components thereof, may be an example of means for performing various aspects of techniques for implementing RISs in mTRP communications as described herein. For example, the communications manager 720 may include a class indication manager 725, a RIS identifier manager 730, a RIS configuration manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a RIS controller in accordance with examples as disclosed herein. The class indication manager 725 may be configured as or otherwise support a means for transmitting a first message indicating a class of a first RIS of one or more RISs served by the RIS controller, the class associated with one or more capabilities of the first RIS. The RIS identifier manager 730 may be configured as or otherwise support a means for receiving a second message that includes an indication of one or more identifiers associated with the first RIS, a quantity of the one or more identifiers associated with the first RIS based on the class associated with the first RIS. The RIS configuration manager 735 may be configured as or otherwise support a means for receiving a third message indicating, via the one or more identifiers, a configuration for the first RIS for communications between the first RIS and one or more network entities.

Additionally, or alternatively, the communications manager 720 may support wireless communications at a network entity in accordance with examples as disclosed herein. The class indication manager 725 may be configured as or otherwise support a means for receiving a first message indicating a class of a first RIS of one or more RISs served by a RIS controller, the class associated with one or more capabilities of the first RIS. The RIS identifier manager 730 may be configured as or otherwise support a means for transmitting a second message that includes an indication of one or more identifiers associated with the first RIS, a quantity of the one or more identifiers associated with the first RIS based on the class associated with the first RIS. The RIS configuration manager 735 may be configured as or otherwise support a means for transmitting a third message indicating, via the one or more identifiers, a configuration for the first RIS for communications between the first RIS and one or more network entities.

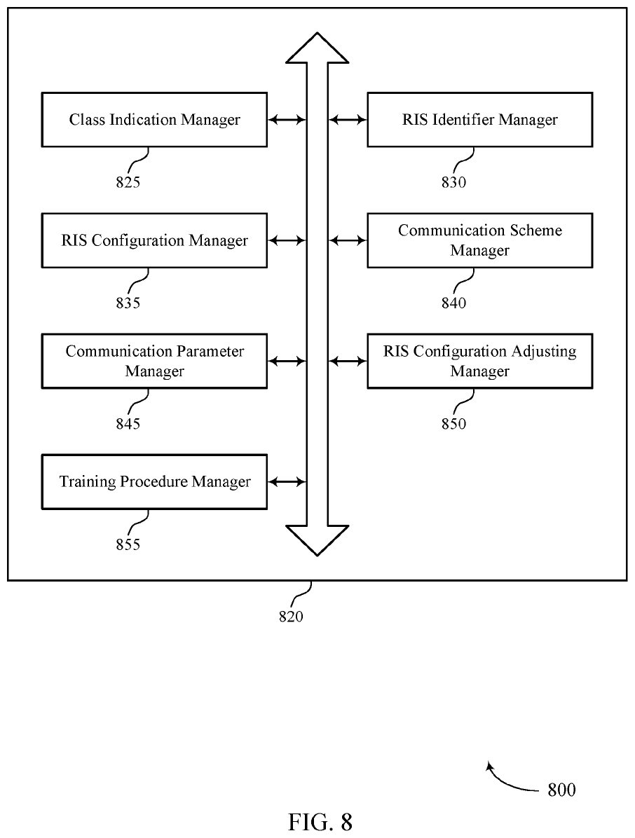

FIG. 8 shows a block diagram 800 of a communications manager 820 that supports techniques for implementing RISs in mTRP communications in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for implementing RISs in mTRP communications as described herein. For example, the communications manager 820 may include a class indication manager 825, a RIS identifier manager 830, a RIS configuration manager 835, a communication scheme manager 840, a communication parameter manager 845, a RIS configuration adjusting manager 850, a training procedure manager 855, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 820 may support wireless communications at a RIS controller in accordance with examples as disclosed herein. The class indication manager 825 may be configured as or otherwise support a means for transmitting a first message indicating a class of a first RIS of one or more RISs served by the RIS controller, the class associated with one or more capabilities of the first RIS. The RIS identifier manager 830 may be configured as or otherwise support a means for receiving a second message that includes an indication of one or more identifiers associated with the first RIS, a quantity of the one or more identifiers associated with the first RIS based on the class associated with the first RIS. The RIS configuration manager 835 may be configured as or otherwise support a means for receiving a third message indicating, via the one or more identifiers, a configuration for the first RIS for communications between the first RIS and one or more network entities.

In some examples, to support transmitting the first message, the class indication manager 825 may be configured as or otherwise support a means for transmitting the first message indicating a number of RIS elements of the first RIS.

In some examples, to support transmitting the first message, the class indication manager 825 may be configured as or otherwise support a means for transmitting the first message indicating a number of sub-RISs supported by the first RIS.

In some examples, to support transmitting the first message, the class indication manager 825 may be configured as or otherwise support a means for transmitting the first message indicating a number of RIS elements the first RIS supports per sub-RIS.

In some examples, to support transmitting the first message, the class indication manager 825 may be configured as or otherwise support a means for transmitting the first message indicating one or more codebook-based or non-codebook based beams supported by the first RIS.

In some examples, to support transmitting the first message, the class indication manager 825 may be configured as or otherwise support a means for transmitting the first message indicating a duration of time in which the first RIS is capable of switching between configurations of the first RIS.

In some examples, to support transmitting the first message, the class indication manager 825 may be configured as or otherwise support a means for transmitting the first message indicating a granularity of weights associated with RIS elements of the first RIS.

In some examples, to support transmitting the first message, the class indication manager 825 may be configured as or otherwise support a means for transmitting the first message indicating whether the first RIS is capable of switching configurations across frequencies.

In some examples, to support transmitting the first message, the class indication manager 825 may be configured as or otherwise support a means for transmitting the first message indicating a bandwidth size over which the first RIS is capable of switching configurations.

In some examples, to support transmitting the first message, the class indication manager 825 may be configured as or otherwise support a means for transmitting the first message indicating one or more modem types the first RIS is configured with.

In some examples, the communication scheme manager 840 may be configured as or otherwise support a means for receiving a signal indicating a set of one or more communication scheme identifiers, each communication scheme identifier associated with a set of one or more network entities and a communication type, where the communication type is one of spatial division multiplexing, frequency division multiplexing, or time division multiplexing.

In some examples, the training procedure manager 855 may be configured as or otherwise support a means for receiving a trigger to perform a training procedure, the trigger including a communication scheme identifier from the set of one or more communication scheme identifiers, a set of network entities involved in the training procedure, the communication type associated with the training procedure, a RIS identifier to be used for the training procedure, or a combination thereof. In some examples, the training procedure manager 855 may be configured as or otherwise support a means for performing the training procedure in accordance with the trigger to determine one or more preferred RIS beams associated with the training procedure.

In some examples, to support receiving the third message, the communication scheme manager 840 may be configured as or otherwise support a means for receiving the third message indicating a communication scheme identifier, the communication scheme identifier indicative of the configuration for the first RIS for the communications between the first RIS and the one or more network entities.

In some examples, the communication scheme identifier is included in a transmission configuration indicator state indication, a quasi-colocation indication, or both.

In some examples, the quasi-colocation indication is associated with quasi-colocation type D.

In some examples, the configuration for the first RIS indicated via the one or more identifiers is included in a transmission configuration indicator state indication, a quasi-colocation indication, or both.

In some examples, the quasi-colocation indication is associated with quasi-colocation type D.

In some examples, the communication parameter manager 845 may be configured as or otherwise support a means for receiving a signal indicating one or more parameters associated with the communications between the first RIS and the one or more network entities, where the one or more network entities are each a TRP.

In some examples, the one or more parameters include allocated resources, the one or more network entities, a communication type, or a combination thereof for the communications between the first RIS and the one or more network entities.

In some examples, the signal is received with the third message, or separate from the third message.

In some examples, the signal is included in a downlink control information message intended for the RIS controller, or included in a group-common downlink control information message.

In some examples, the RIS configuration adjusting manager 850 may be configured as or otherwise support a means for adjusting the configuration of the first RIS in accordance with the configuration indicated in the third message.

In some examples, to support receiving the third message, the RIS configuration manager 835 may be configured as or otherwise support a means for receiving a downlink control information message including the third message.

In some examples, the first RIS is associated with a set of frequency resources, one or more UEs, or a combination thereof.

In some examples, the first RIS includes one or more sub-RISs.

In some examples, each sub-RIS is associated with a set of frequency resources, one or more UEs, or a combination thereof.

In some examples, the communications between the first RIS and the one or more network entities include downlink communications, uplink communications, or a combination thereof.

Additionally, or alternatively, the communications manager 820 may support wireless communications at a network entity in accordance with examples as disclosed herein. In some examples, the class indication manager 825 may be configured as or otherwise support a means for receiving a first message indicating a class of a first RIS of one or more RISs served by a RIS controller, the class associated with one or more capabilities of the first RIS. In some examples, the RIS identifier manager 830 may be configured as or otherwise support a means for transmitting a second message that includes an indication of one or more identifiers associated with the first RIS, a quantity of the one or more identifiers associated with the first RIS based on the class associated with the first RIS. In some examples, the RIS configuration manager 835 may be configured as or otherwise support a means for transmitting a third message indicating, via the one or more identifiers, a configuration for the first RIS for communications between the first RIS and one or more network entities.

In some examples, to support receiving the first message, the class indication manager 825 may be configured as or otherwise support a means for receiving the first message indicating a number of RIS elements of the first RIS.

In some examples, to support receiving the first message, the class indication manager 825 may be configured as or otherwise support a means for receiving the first message indicating a number of sub-RISs supported by the first RIS.

In some examples, to support receiving the first message, the class indication manager 825 may be configured as or otherwise support a means for receiving the first message indicating a number of RIS elements the first RIS supports per sub-RIS.

In some examples, to support receiving the first message, the class indication manager 825 may be configured as or otherwise support a means for receiving the first message indicating one or more codebook-based or non-codebook based beams supported by the first RIS.

In some examples, to support receiving the first message, the class indication manager 825 may be configured as or otherwise support a means for receiving the first message indicating a duration of time in which the first RIS is capable of switching between configurations of the first RIS.

In some examples, to support receiving the first message, the class indication manager 825 may be configured as or otherwise support a means for receiving the first message indicating a granularity of weights associated with RIS elements of the first RIS.

In some examples, to support receiving the first message, the class indication manager 825 may be configured as or otherwise support a means for receiving the first message indicating whether the first RIS is capable of switching configurations across frequencies.

In some examples, to support receiving the first message, the class indication manager 825 may be configured as or otherwise support a means for receiving the first message indicating a bandwidth size over which the first RIS is capable of switching configurations.

In some examples, to support receiving the first message, the class indication manager 825 may be configured as or otherwise support a means for receiving the first message indicating one or more modem types the first RIS is configured with.

In some examples, the communication scheme manager 840 may be configured as or otherwise support a means for transmitting a signal indicating a set of one or more communication scheme identifiers, each communication scheme identifier associated with a set of one or more network entities and a communication type, where the communication type is one of spatial division multiplexing, frequency division multiplexing, or time division multiplexing.

In some examples, the training procedure manager 855 may be configured as or otherwise support a means for transmitting a trigger to perform a training procedure, the trigger including a communication scheme identifier from the set of one or more communication scheme identifiers, a set of network entities involved in the training procedure, the communication type associated with the training procedure, a RIS identifier to be used for the training procedure, or a combination thereof. In some examples, the training procedure manager 855 may be configured as or otherwise support a means for performing the training procedure in accordance with the trigger to determine one or more preferred RIS beams associated with the training procedure by transmitting or receiving one or more reference signals to or from the first RIS, respectively.

In some examples, to support transmitting the third message, the communication scheme manager 840 may be configured as or otherwise support a means for transmitting the third message indicating a communication scheme identifier, the communication scheme identifier indicative of the configuration for the first RIS for the communications between the first RIS and the one or more network entities.

In some examples, the communication scheme identifier is included in a transmission configuration indicator state indication, a quasi-colocation indication, or both.

In some examples, the quasi-colocation indication is associated with quasi-colocation type D.

In some examples, the configuration for the first RIS indicated via the one or more identifiers is included in a transmission configuration indicator state indication, a quasi-colocation indication, or both.

In some examples, the quasi-colocation indication is associated with quasi-colocation type D.

In some examples, the communication parameter manager 845 may be configured as or otherwise support a means for transmitting a signal indicating one or more parameters associated with the communications between the first RIS and the one or more network entities, where the one or more network entities are each a TRP.

In some examples, the one or more parameters include allocated resources, the one or more network entities, a communication type, or a combination thereof for the communications between the first RIS and the one or more network entities.

In some examples, the signal is received with the third message, or separate from the third message.

In some examples, the signal is included in a downlink control information message intended for the RIS controller, or included in a group-common downlink control information message.

In some examples, to support transmitting the third message, the RIS configuration manager 835 may be configured as or otherwise support a means for transmitting a downlink control information message including the third message.

In some examples, the first RIS is associated with a set of frequency resources, one or more UEs, or a combination thereof.

In some examples, the first RIS includes one or more sub-RISs.

In some examples, each sub-RIS is associated with a set of frequency resources, one or more UEs, or a combination thereof.

In some examples, the communications between the first RIS and the network entity include downlink communications, uplink communications, or a combination thereof.

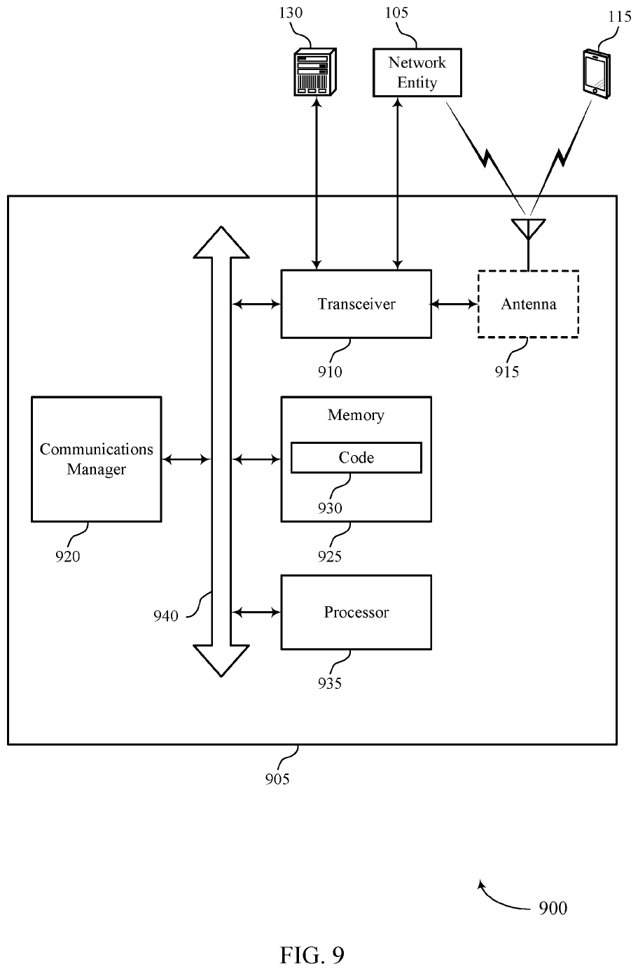

FIG. 9 shows a diagram of a system 900 including a device 905 that supports techniques for implementing RISs in mTRP communications in accordance with one or more aspects of the present disclosure. The device 905 may be an example of or include the components of a device 605, a device 705, or a network entity 105 as described herein. The device 905 may communicate with one or more network entities 105, one or more UEs 115, or any combination thereof, which may include communications over one or more wired interfaces, over one or more wireless interfaces, or any combination thereof. The device 905 may include components that support outputting and obtaining communications, such as a communications manager 920, a transceiver 910, an antenna 915, a memory 925, code 930, and a processor 935. These components may be in electronic communication or otherwise coupled (e.g., operatively, communicatively, functionally, electronically, electrically) via one or more buses (e.g., a bus 940).

The transceiver 910 may support bi-directional communications via wired links, wireless links, or both as described herein. In some examples, the transceiver 910 may include a wired transceiver and may communicate bi-directionally with another wired transceiver. Additionally, or alternatively, in some examples, the transceiver 910 may include a wireless transceiver and may communicate bi-directionally with another wireless transceiver. In some examples, the device 905 may include one or more antennas 915, which may be capable of transmitting or receiving wireless transmissions (e.g., concurrently). The transceiver 910 may also include a modem to modulate signals, to provide the modulated signals for transmission (e.g., by one or more antennas 915, by a wired transmitter), to receive modulated signals (e.g., from one or more antennas 915, from a wired receiver), and to demodulate signals. The transceiver 910, or the transceiver 910 and one or more antennas 915 or wired interfaces, where applicable, may be an example of a transmitter 615, a transmitter 715, a receiver 610, a receiver 710, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 925 may include RAM and ROM. The memory 925 may store computer-readable, computer-executable code 930 including instructions that, when executed by the processor 935, cause the device 905 to perform various functions described herein. The code 930 may be stored in a non-transitory computer-readable medium such as system memory or another type of memory. In some cases, the code 930 may not be directly executable by the processor 935 but may cause a computer (e.g., when compiled and executed) to perform functions described herein. In some cases, the memory 925 may contain, among other things, a BIOS which may control basic hardware or software operation such as the interaction with peripheral components or devices.

The processor 935 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 935 may be configured to operate a memory array using a memory controller. In some other cases, a memory controller may be integrated into the processor 935. The processor 935 may be configured to execute computer-readable instructions stored in a memory (e.g., the memory 925) to cause the device 905 to perform various functions (e.g., functions or tasks supporting techniques for implementing RISs in mTRP communications). For example, the device 905 or a component of the device 905 may include a processor 935 and memory 925 coupled with the processor 935, the processor 935 and memory 925 configured to perform various functions described herein. The processor 935 may be an example of a cloud-computing platform (e.g., one or more physical nodes and supporting software such as operating systems, virtual machines, or container instances) that may host the functions (e.g., by executing code 930) to perform the functions of the device 905.

In some examples, a bus 940 may support communications of (e.g., within) a protocol layer of a protocol stack. In some examples, a bus 940 may support communications associated with a logical channel of a protocol stack (e.g., between protocol layers of a protocol stack), which may include communications performed within a component of the device 905, or between different components of the device 905 that may be co-located or located in different locations (e.g., where the device 905 may refer to a system in which one or more of the communications manager 920, the transceiver 910, the memory 925, the code 930, and the processor 935 may be located in one of the different components or divided between different components).

In some examples, the communications manager 920 may manage aspects of communications with a core network 130 (e.g., via one or more wired or wireless backhaul links). For example, the communications manager 920 may manage the transfer of data communications for client devices, such as one or more UEs 115. In some examples, the communications manager 920 may manage communications with other network entities 105, and may include a controller or scheduler for controlling communications with UEs 115 in cooperation with other network entities 105. In some examples, the communications manager 920 may support an X2 interface within an LTE/LTE-A wireless communications network technology to provide communication between network entities 105.

The communications manager 920 may support wireless communications at a RIS controller in accordance with examples as disclosed herein. For example, the communications manager 920 may be configured as or otherwise support a means for transmitting a first message indicating a class of a first RIS of one or more RISs served by the RIS controller, the class associated with one or more capabilities of the first RIS. The communications manager 920 may be configured as or otherwise support a means for receiving a second message that includes an indication of one or more identifiers associated with the first RIS, a quantity of the one or more identifiers associated with the first RIS based on the class associated with the first RIS. The communications manager 920 may be configured as or otherwise support a means for receiving a third message indicating, via the one or more identifiers, a configuration for the first RIS for communications between the first RIS and one or more network entities.

Additionally, or alternatively, the communications manager 920 may support wireless communications at a network entity in accordance with examples as disclosed herein. For example, the communications manager 920 may be configured as or otherwise support a means for receiving a first message indicating a class of a first RIS of one or more RISs served by a RIS controller, the class associated with one or more capabilities of the first RIS. The communications manager 920 may be configured as or otherwise support a means for transmitting a second message that includes an indication of one or more identifiers associated with the first RIS, a quantity of the one or more identifiers associated with the first RIS based on the class associated with the first RIS. The communications manager 920 may be configured as or otherwise support a means for transmitting a third message indicating, via the one or more identifiers, a configuration for the first RIS for communications between the first RIS and one or more network entities.

By including or configuring the communications manager 920 in accordance with examples as described herein, the device 905 may support techniques for improved communication reliability, more efficient utilization of communication resources, and improved coordination between devices.

In some examples, the communications manager 920 may be configured to perform various operations (e.g., receiving, obtaining, monitoring, outputting, transmitting) using or otherwise in cooperation with the transceiver 910, the one or more antennas 915 (e.g., where applicable), or any combination thereof. Although the communications manager 920 is illustrated as a separate component, in some examples, one or more functions described with reference to the communications manager 920 may be supported by or performed by the processor 935, the memory 925, the code 930, the transceiver 910, or any combination thereof. For example, the code 930 may include instructions executable by the processor 935 to cause the device 905 to perform various aspects of techniques for implementing RISs in mTRP communications as described herein, or the processor 935 and the memory 925 may be otherwise configured to perform or support such operations.

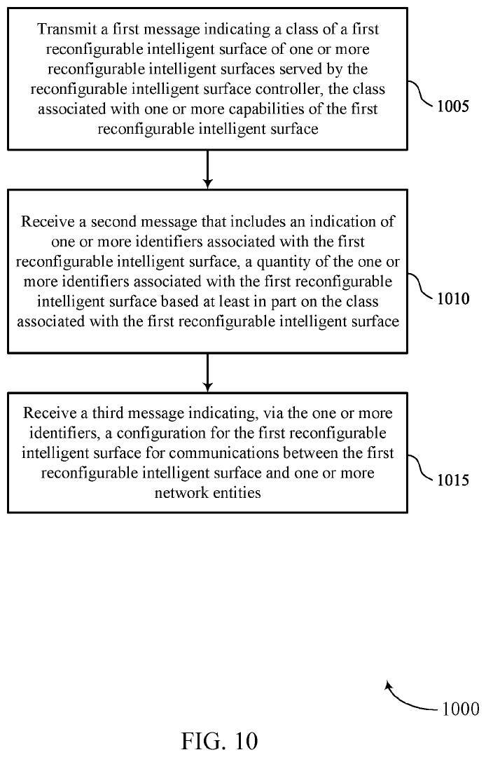

FIG. 10 shows a flowchart illustrating a method 1000 that supports techniques for implementing RISs in mTRP communications in accordance with one or more aspects of the present disclosure. The operations of the method 1000 may be implemented by a network entity or its components as described herein. For example, the operations of the method 1000 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1005, the method may include transmitting a first message indicating a class of a first RIS of one or more RISs served by the RIS controller, the class associated with one or more capabilities of the first RIS. The operations of 1005 may be performed in accordance with examples as disclosed herein. In some examples, aspects of the operations of 1005 may be performed by a class indication manager 825 as described with reference to FIG. 8.

At 1010, the method may include receiving a second message that includes an indication of one or more identifiers associated with the first RIS, a quantity of the one or more identifiers associated with the first RIS based on the class associated with the first RIS. The operations of 1010 may be performed in accordance with examples as disclosed herein. In some examples, aspects of the operations of 1010 may be performed by a RIS identifier manager 830 as described with reference to FIG. 8.

At 1015, the method may include receiving a third message indicating, via the one or more identifiers, a configuration for the first RIS for communications between the first RIS and one or more network entities. The operations of 1015 may be performed in accordance with examples as disclosed herein. In some examples, aspects of the operations of 1015 may be performed by a RIS configuration manager 835 as described with reference to FIG. 8.

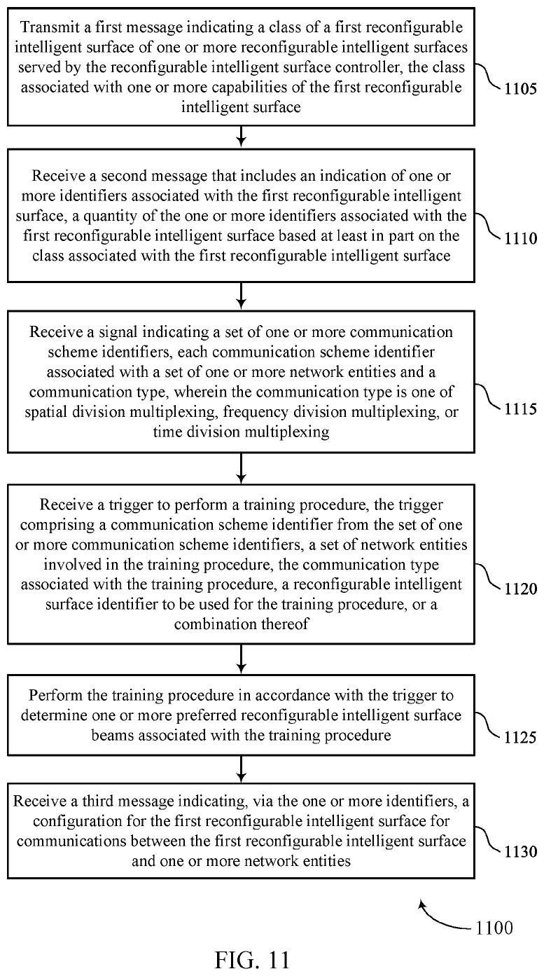

FIG. 11 shows a flowchart illustrating a method 1100 that supports techniques for implementing RISs in mTRP communications in accordance with one or more aspects of the present disclosure. The operations of the method 1100 may be implemented by a network entity or its components as described herein. For example, the operations of the method 1100 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1105, the method may include transmitting a first message indicating a class of a first RIS of one or more RISs served by the RIS controller, the class associated with one or more capabilities of the first RIS. The operations of 1105 may be performed in accordance with examples as disclosed herein. In some examples, aspects of the operations of 1105 may be performed by a class indication manager 825 as described with reference to FIG. 8.

At 1110, the method may include receiving a second message that includes an indication of one or more identifiers associated with the first RIS, a quantity of the one or more identifiers associated with the first RIS based on the class associated with the first RIS. The operations of 1110 may be performed in accordance with examples as disclosed herein. In some examples, aspects of the operations of 1110 may be performed by a RIS identifier manager 830 as described with reference to FIG. 8.

At 1115, the method may include receiving a signal indicating a set of one or more communication scheme identifiers, each communication scheme identifier associated with a set of one or more network entities and a communication type, where the communication type is one of spatial division multiplexing, frequency division multiplexing, or time division multiplexing. The operations of 1115 may be performed in accordance with examples as disclosed herein. In some examples, aspects of the operations of 1115 may be performed by a communication scheme manager 840 as described with reference to FIG. 8.

At 1120, the method may include receiving a trigger to perform a training procedure, the trigger including a communication scheme identifier from the set of one or more communication scheme identifiers, a set of network entities involved in the training procedure, the communication type associated with the training procedure, a RIS identifier to be used for the training procedure, or a combination thereof. The operations of 1120 may be performed in accordance with examples as disclosed herein. In some examples, aspects of the operations of 1120 may be performed by a training procedure manager 855 as described with reference to FIG. 8.

At 1125, the method may include performing the training procedure in accordance with the trigger to determine one or more preferred RIS beams associated with the training procedure. The operations of 1125 may be performed in accordance with examples as disclosed herein. In some examples, aspects of the operations of 1125 may be performed by a training procedure manager 855 as described with reference to FIG. 8.

At 1130, the method may include receiving a third message indicating, via the one or more identifiers, a configuration for the first RIS for communications between the first RIS and one or more network entities. The operations of 1130 may be performed in accordance with examples as disclosed herein. In some examples, aspects of the operations of 1130 may be performed by a RIS configuration manager 835 as described with reference to FIG. 8.

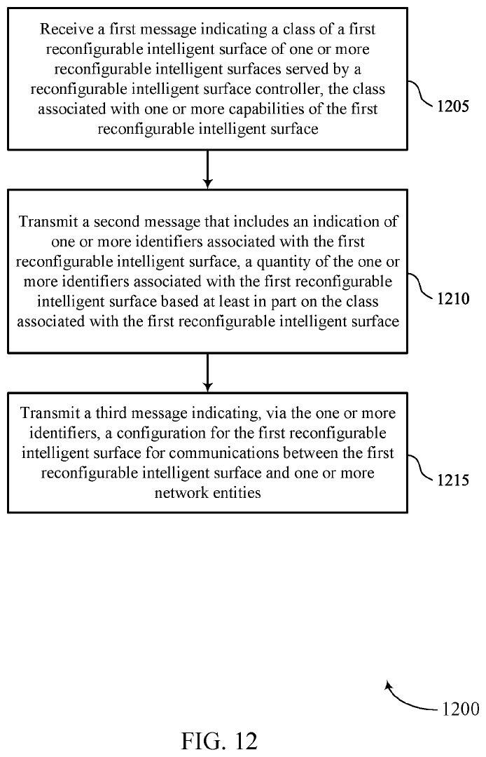

FIG. 12 shows a flowchart illustrating a method 1200 that supports techniques for implementing RISs in mTRP communications in accordance with one or more aspects of the present disclosure. The operations of the method 1200 may be implemented by a network entity or its components as described herein. For example, the operations of the method 1200 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1205, the method may include receiving a first message indicating a class of a first RIS of one or more RISs served by a RIS controller, the class associated with one or more capabilities of the first RIS. The operations of 1205 may be performed in accordance with examples as disclosed herein. In some examples, aspects of the operations of 1205 may be performed by a class indication manager 825 as described with reference to FIG. 8.

At 1210, the method may include transmitting a second message that includes an indication of one or more identifiers associated with the first RIS, a quantity of the one or more identifiers associated with the first RIS based on the class associated with the first RIS. The operations of 1210 may be performed in accordance with examples as disclosed herein. In some examples, aspects of the operations of 1210 may be performed by a RIS identifier manager 830 as described with reference to FIG. 8.

At 1215, the method may include transmitting a third message indicating, via the one or more identifiers, a configuration for the first RIS for communications between the first RIS and one or more network entities. The operations of 1215 may be performed in accordance with examples as disclosed herein. In some examples, aspects of the operations of 1215 may be performed by a RIS configuration manager 835 as described with reference to FIG. 8.

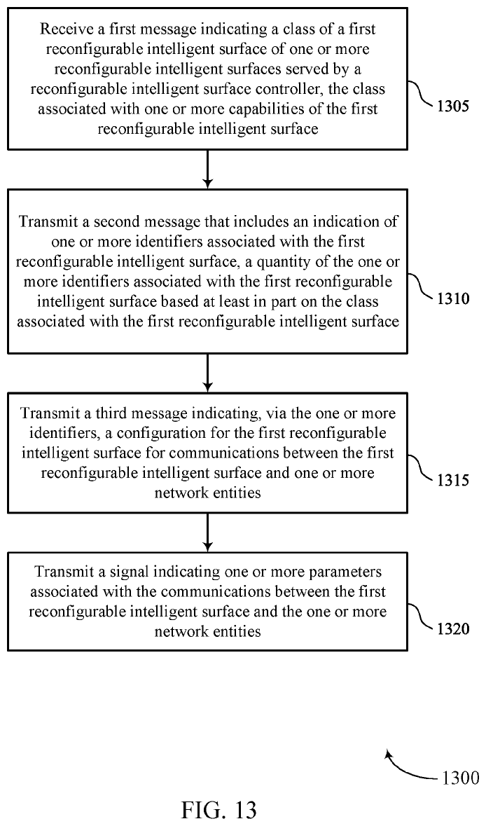

FIG. 13 shows a flowchart illustrating a method 1300 that supports techniques for implementing RISs in mTRP communications in accordance with one or more aspects of the present disclosure. The operations of the method 1300 may be implemented by a network entity or its components as described herein. For example, the operations of the method 1300 may be performed by a network entity as described with reference to FIGS. 1 through 9. In some examples, a network entity may execute a set of instructions to control the functional elements of the network entity to perform the described functions. Additionally, or alternatively, the network entity may perform aspects of the described functions using special-purpose hardware.

At 1305, the method may include receiving a first message indicating a class of a first RIS of one or more RISs served by a RIS controller, the class associated with one or more capabilities of the first RIS. The operations of 1305 may be performed in accordance with examples as disclosed herein. In some examples, aspects of the operations of 1305 may be performed by a class indication manager 825 as described with reference to FIG. 8.

At 1310, the method may include transmitting a second message that includes an indication of one or more identifiers associated with the first RIS, a quantity of the one or more identifiers associated with the first RIS based on the class associated with the first RIS. The operations of 1310 may be performed in accordance with examples as disclosed herein. In some examples, aspects of the operations of 1310 may be performed by a RIS identifier manager 830 as described with reference to FIG. 8.

At 1315, the method may include transmitting a third message indicating, via the one or more identifiers, a configuration for the first RIS for communications between the first RIS and one or more network entities. The operations of 1315 may be performed in accordance with examples as disclosed herein. In some examples, aspects of the operations of 1315 may be performed by a RIS configuration manager 835 as described with reference to FIG. 8.

At 1320, the method may include transmitting a signal indicating one or more parameters associated with the communications between the first RIS and the one or more network entities. The operations of 1320 may be performed in accordance with examples as disclosed herein. In some examples, aspects of the operations of 1320 may be performed by a communication parameter manager 845 as described with reference to FIG. 8.

The following provides an overview of aspects of the present disclosure:

Aspect 1: A method for wireless communications at a reconfigurable intelligent surface controller, comprising: transmitting a first message indicating a class of a first reconfigurable intelligent surface of one or more reconfigurable intelligent surfaces served by the reconfigurable intelligent surface controller, the class associated with one or more capabilities of the first reconfigurable intelligent surface; receiving a second message that includes an indication of one or more identifiers associated with the first reconfigurable intelligent surface, a quantity of the one or more identifiers associated with the first reconfigurable intelligent surface based at least in part on the class associated with the first reconfigurable intelligent surface; and receiving a third message indicating, via the one or more identifiers, a configuration for the first reconfigurable intelligent surface for communications between the first reconfigurable intelligent surface and one or more network entities.

Aspect 2: The method of aspect 1, wherein transmitting the first message further comprises: transmitting the first message indicating a number of reconfigurable intelligent surface elements of the first reconfigurable intelligent surface.

Aspect 3: The method of any of aspects 1 through 2, wherein transmitting the first message further comprises: transmitting the first message indicating a number of sub-reconfigurable intelligent surfaces supported by the first reconfigurable intelligent surface.

Aspect 4: The method of any of aspects 1 through 3, wherein transmitting the first message further comprises: transmitting the first message indicating a number of reconfigurable intelligent surface elements the first reconfigurable intelligent surface supports per sub-reconfigurable intelligent surface.

Aspect 5: The method of any of aspects 1 through 4, wherein transmitting the first message further comprises: transmitting the first message indicating one or more codebook-based or non-codebook based beams supported by the first reconfigurable intelligent surface.

Aspect 6: The method of any of aspects 1 through 5, wherein transmitting the first message further comprises: transmitting the first message indicating a duration of time in which the first reconfigurable intelligent surface is capable of switching between configurations of the first reconfigurable intelligent surface.

Aspect 7: The method of any of aspects 1 through 6, wherein transmitting the first message further comprises: transmitting the first message indicating a granularity of weights associated with reconfigurable intelligent surface elements of the first reconfigurable intelligent surface.

Aspect 8: The method of any of aspects 1 through 7, wherein transmitting the first message further comprises: transmitting the first message indicating whether the first reconfigurable intelligent surface is capable of switching configurations across frequencies.

Aspect 9: The method of any of aspects 1 through 8, wherein transmitting the first message further comprises: transmitting the first message indicating a bandwidth size over which the first reconfigurable intelligent surface is capable of switching configurations.

Aspect 10: The method of any of aspects 1 through 9, wherein transmitting the first message further comprises: transmitting the first message indicating one or more modem types the first reconfigurable intelligent surface is configured with.

Aspect 11: The method of any of aspects 1 through 10, further comprising: receiving a signal indicating a set of one or more communication scheme identifiers, each communication scheme identifier associated with a set of one or more network entities and a communication type, wherein the communication type is one of spatial division multiplexing, frequency division multiplexing, or time division multiplexing.

Aspect 12: The method of aspect 11, further comprising: receiving a trigger to perform a training procedure, the trigger comprising a communication scheme identifier from the set of one or more communication scheme identifiers, a set of network entities involved in the training procedure, the communication type associated with the training procedure, a reconfigurable intelligent surface identifier to be used for the training procedure, or a combination thereof; and performing the training procedure in accordance with the trigger to determine one or more preferred reconfigurable intelligent surface beams associated with the training procedure.

Aspect 13: The method of any of aspects 1 through 12, wherein receiving the third message further comprises: receiving the third message indicating a communication scheme identifier, the communication scheme identifier indicative of the configuration for the first reconfigurable intelligent surface for the communications between the first reconfigurable intelligent surface and the one or more network entities.

Aspect 14: The method of aspect 13, wherein the communication scheme identifier is included in a transmission configuration indicator state indication, a quasi-colocation indication, or both.

Aspect 15: The method of aspect 14, wherein the quasi-colocation indication is associated with quasi-colocation type D.

Aspect 16: The method of any of aspects 1 through 15, wherein the configuration for the first reconfigurable intelligent surface indicated via the one or more identifiers is included in a transmission configuration indicator state indication, a quasi-colocation indication, or both.

Aspect 17: The method of aspect 16, wherein the quasi-colocation indication is associated with quasi-colocation type D.

Aspect 18: The method of any of aspects 1 through 17, further comprising: receiving a signal indicating one or more parameters associated with the communications between the first reconfigurable intelligent surface and the one or more network entities, wherein the one or more network entities are each a transmission and reception point.

Aspect 19: The method of aspect 18, wherein the one or more parameters comprise allocated resources, the one or more network entities, a communication type, or a combination thereof for the communications between the first reconfigurable intelligent surface and the one or more network entities.

Aspect 20: The method of any of aspects 18 through 19, wherein the signal is received with the third message, or separate from the third message.

Aspect 21: The method of any of aspects 18 through 20, wherein the signal is included in a downlink control information message intended for the reconfigurable intelligent surface controller, or included in a group-common downlink control information message.

Aspect 22: The method of any of aspects 1 through 21, further comprising: adjusting the configuration of the first reconfigurable intelligent surface in accordance with the configuration indicated in the third message.

Aspect 23: The method of any of aspects 1 through 22, wherein receiving the third message further comprises: receiving a downlink control information message comprising the third message.

Aspect 24: The method of any of aspects 1 through 23, wherein the first reconfigurable intelligent surface is associated with a set of frequency resources, one or more user equipment's (UEs), or a combination thereof.

Aspect 25: The method of any of aspects 1 through 24, wherein the first reconfigurable intelligent surface comprises one or more sub-reconfigurable intelligent surfaces.

Aspect 26: The method of aspect 25, wherein each sub-reconfigurable intelligent surface is associated with a set of frequency resources, one or more user equipment's (UEs), or a combination thereof.

Aspect 27: The method of any of aspects 1 through 26, wherein the communications between the first reconfigurable intelligent surface and the one or more network entities comprise downlink communications, uplink communications, or a combination thereof.

Aspect 28: A method for wireless communications at a network entity, comprising: receiving a first message indicating a class of a first reconfigurable intelligent surface of one or more reconfigurable intelligent surfaces served by a reconfigurable intelligent surface controller, the class associated with one or more capabilities of the first reconfigurable intelligent surface; transmitting a second message that includes an indication of one or more identifiers associated with the first reconfigurable intelligent surface, a quantity of the one or more identifiers associated with the first reconfigurable intelligent surface based at least in part on the class associated with the first reconfigurable intelligent surface; and transmitting a third message indicating, via the one or more identifiers, a configuration for the first reconfigurable intelligent surface for communications between the first reconfigurable intelligent surface and one or more network entities.

Aspect 29: The method of aspect 28, wherein receiving the first message further comprises: receiving the first message indicating a number of reconfigurable intelligent surface elements of the first reconfigurable intelligent surface.

Aspect 30: The method of any of aspects 28 through 29, wherein receiving the first message further comprises: receiving the first message indicating a number of sub-reconfigurable intelligent surfaces supported by the first reconfigurable intelligent surface.

Aspect 31: The method of any of aspects 28 through 30, wherein receiving the first message further comprises: receiving the first message indicating a number of reconfigurable intelligent surface elements the first reconfigurable intelligent surface supports per sub-reconfigurable intelligent surface.

Aspect 32: The method of any of aspects 28 through 31, wherein receiving the first message further comprises: receiving the first message indicating one or more codebook-based or non-codebook based beams supported by the first reconfigurable intelligent surface.

Aspect 33: The method of any of aspects 28 through 32, wherein receiving the first message further comprises: receiving the first message indicating a duration of time in which the first reconfigurable intelligent surface is capable of switching between configurations of the first reconfigurable intelligent surface.

Aspect 34: The method of any of aspects 28 through 33, wherein receiving the first message further comprises: receiving the first message indicating a granularity of weights associated with reconfigurable intelligent surface elements of the first reconfigurable intelligent surface.

Aspect 35: The method of any of aspects 28 through 34, wherein receiving the first message further comprises: receiving the first message indicating whether the first reconfigurable intelligent surface is capable of switching configurations across frequencies.

Aspect 36: The method of any of aspects 28 through 35, wherein receiving the first message further comprises: receiving the first message indicating a bandwidth size over which the first reconfigurable intelligent surface is capable of switching configurations.

Aspect 37: The method of any of aspects 28 through 36, wherein receiving the first message further comprises: receiving the first message indicating one or more modem types the first reconfigurable intelligent surface is configured with.

Aspect 38: The method of any of aspects 28 through 37, further comprising: transmitting a signal indicating a set of one or more communication scheme identifiers, each communication scheme identifier associated with a set of one or more network entities and a communication type, wherein the communication type is one of spatial division multiplexing, frequency division multiplexing, or time division multiplexing.

Aspect 39: The method of aspect 38, further comprising: transmitting a trigger to perform a training procedure, the trigger comprising a communication scheme identifier from the set of one or more communication scheme identifiers, a set of network entities involved in the training procedure, the communication type associated with the training procedure, a reconfigurable intelligent surface identifier to be used for the training procedure, or a combination thereof; and performing the training procedure in accordance with the trigger to determine one or more preferred reconfigurable intelligent surface beams associated with the training procedure by transmitting or receiving one or more reference signals to or from the first reconfigurable intelligent surface, respectively.

Aspect 40: The method of any of aspects 28 through 39, wherein transmitting the third message further comprises: transmitting the third message indicating a communication scheme identifier, the communication scheme identifier indicative of the configuration for the first reconfigurable intelligent surface for the communications between the first reconfigurable intelligent surface and the one or more network entities.

Aspect 41: The method of aspect 40, wherein the communication scheme identifier is included in a transmission configuration indicator state indication, a quasi-colocation indication, or both.

Aspect 42: The method of aspect 41, wherein the quasi-colocation indication is associated with quasi-colocation type D.

Aspect 43: The method of any of aspects 28 through 42, wherein the configuration for the first reconfigurable intelligent surface indicated via the one or more identifiers is included in a transmission configuration indicator state indication, a quasi-colocation indication, or both.

Aspect 44: The method of aspect 43, wherein the quasi-colocation indication is associated with quasi-colocation type D.

Aspect 45: The method of any of aspects 28 through 44, further comprising: transmitting a signal indicating one or more parameters associated with the communications between the first reconfigurable intelligent surface and the one or more network entities.

Aspect 46: The method of aspect 45, wherein the one or more parameters comprise allocated resources, the one or more network entities, a communication type, or a combination thereof for the communications between the first reconfigurable intelligent surface and the one or more network entities.

Aspect 47: The method of any of aspects 45 through 46, wherein the signal is received with the third message, or separate from the third message.

Aspect 48: The method of any of aspects 45 through 47, wherein the signal is included in a downlink control information message intended for the reconfigurable intelligent surface controller, or included in a group-common downlink control information message.

Aspect 49: The method of any of aspects 28 through 48, wherein transmitting the third message further comprises: transmitting a downlink control information message comprising the third message.

Aspect 50: The method of any of aspects 28 through 49, wherein the first reconfigurable intelligent surface is associated with a set of frequency resources, one or more user equipment's (UEs), or a combination thereof.

Aspect 51: The method of any of aspects 28 through 50, wherein the first reconfigurable intelligent surface comprises one or more sub-reconfigurable intelligent surfaces.

Aspect 52: The method of aspect 51, wherein each sub-reconfigurable intelligent surface is associated with a set of frequency resources, one or more user equipment's (UEs), or a combination thereof.

Aspect 53: The method of any of aspects 28 through 52, wherein the communications between the first reconfigurable intelligent surface and the network entity comprise downlink communications, uplink communications, or a combination thereof.

Aspect 54: An apparatus for wireless communications, comprising a processor; memory coupled with the processor; and instructions stored in the memory and executable by the processor to cause the apparatus to perform a method of any of aspects 1 through 27.

Aspect 55: An apparatus for wireless communications, comprising at least one means for performing a method of any of aspects 1 through 27.

Aspect 56: A non-transitory computer-readable medium storing code for wireless communications, the code comprising instructions executable by a processor to perform a method of any of aspects 1 through 27.

Aspect 57: An apparatus for wireless communications, comprising a processor; memory coupled with the processor; and instructions stored in the memory and executable by the processor to cause the apparatus to perform a method of any of aspects 28 through 53.

Aspect 58: An apparatus for wireless communications, comprising at least one means for performing a method of any of aspects 28 through 53.

Aspect 59: A non-transitory computer-readable medium storing code for wireless communications, the code comprising instructions executable by a processor to perform a method of any of aspects 28 through 53.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a reconfigurable intelligent surface controller, comprising:
transmitting a first message indicating a class of a first reconfigurable intelligent surface of one or more reconfigurable intelligent surfaces served by the reconfigurable intelligent surface controller, the class associated with one or more capabilities of the first reconfigurable intelligent surface;
receiving a second message that includes an indication of one or more identifiers associated with the first reconfigurable intelligent surface, a quantity of the one or more identifiers associated with the first reconfigurable intelligent surface based at least in part on the class associated with the first reconfigurable intelligent surface; and
receiving a third message indicating, via the one or more identifiers, a configuration for the first reconfigurable intelligent surface for communications between the first reconfigurable intelligent surface and one or more network entities.

2. The method of claim 1, wherein transmitting the first message further comprises:
transmitting the first message indicating a number of reconfigurable intelligent surface elements of the first reconfigurable intelligent surface.

3. The method of claim 1, wherein transmitting the first message further comprises:
transmitting the first message indicating a number of sub-reconfigurable intelligent surfaces supported by the first reconfigurable intelligent surface.

4. The method of claim 1, wherein transmitting the first message further comprises:
transmitting the first message indicating a number of reconfigurable intelligent surface elements the first reconfigurable intelligent surface supports per sub-reconfigurable intelligent surface.

5. The method of claim 1, wherein transmitting the first message further comprises:
transmitting the first message indicating one or more codebook-based or non-codebook based beams supported by the first reconfigurable intelligent surface.

6. The method of claim 1, wherein transmitting the first message further comprises:
transmitting the first message indicating a duration of time in which the first reconfigurable intelligent surface is capable of switching between configurations of the first reconfigurable intelligent surface.

7. The method of claim 1, wherein transmitting the first message further comprises:
transmitting the first message indicating a granularity of weights associated with reconfigurable intelligent surface elements of the first reconfigurable intelligent surface.

8. The method of claim 1, wherein transmitting the first message further comprises:
transmitting the first message indicating whether the first reconfigurable intelligent surface is capable of switching configurations across frequencies.

9. The method of claim 1, wherein transmitting the first message further comprises:
transmitting the first message indicating a bandwidth size over which the first reconfigurable intelligent surface is capable of switching configurations.

10. The method of claim 1, wherein transmitting the first message further comprises:
transmitting the first message indicating one or more modem types the first reconfigurable intelligent surface is configured with.

11. The method of claim 1, further comprising:
receiving a signal indicating a set of one or more communication scheme identifiers, each communication scheme identifier associated with a set of one or more network entities and a communication type, wherein the communication type is one of spatial division multiplexing, frequency division multiplexing, or time division multiplexing.

12. The method of claim 11, further comprising:
receiving a trigger to perform a training procedure, the trigger comprising a communication scheme identifier from the set of one or more communication scheme identifiers, a set of network entities involved in the training procedure, the communication type associated with the training procedure, a reconfigurable intelligent surface identifier to be used for the training procedure, or a combination thereof; and
performing the training procedure in accordance with the trigger to determine one or more preferred reconfigurable intelligent surface beams associated with the training procedure.

13. The method of claim 1, wherein receiving the third message further comprises:
receiving the third message indicating a communication scheme identifier, the communication scheme identifier indicative of the configuration for the first reconfigurable intelligent surface for the communications between the first reconfigurable intelligent surface and the one or more network entities.

14. The method of claim 1, further comprising:
receiving a signal indicating one or more parameters associated with the communications between the first reconfigurable intelligent surface and the one or more network entities, wherein the one or more network entities are each a transmission and reception point.

15. The method of claim 1, further comprising:
adjusting the configuration of the first reconfigurable intelligent surface in accordance with the configuration indicated in the third message.

16. An apparatus for wireless communications, comprising:
a processor;
memory coupled with the processor; and
instructions stored in the memory and executable by the processor to cause the apparatus to:
transmit a first message indicating a class of a first reconfigurable intelligent surface of one or more reconfigurable intelligent surfaces served by a reconfigurable intelligent surface controller, the class associated with one or more capabilities of the first reconfigurable intelligent surface;
receive a second message that includes an indication of one or more identifiers associated with the first reconfigurable intelligent surface, a quantity of the one or more identifiers associated with the first reconfigurable intelligent surface based at least in part on the class associated with the first reconfigurable intelligent surface; and
receive a third message indicating, via the one or more identifiers, a configuration for the first reconfigurable intelligent surface for communications between the first reconfigurable intelligent surface and one or more network entities.

17. The apparatus of claim 16, wherein the instructions to transmit the first message are further executable by the processor to cause the apparatus to:
transmit the first message indicating a number of reconfigurable intelligent surface elements of the first reconfigurable intelligent surface.

18. The apparatus of claim 16, wherein the instructions to transmit the first message are further executable by the processor to cause the apparatus to:
transmit the first message indicating a number of sub-reconfigurable intelligent surfaces supported by the first reconfigurable intelligent surface.

19. The apparatus of claim 16, wherein the instructions to transmit the first message are further executable by the processor to cause the apparatus to:
transmit the first message indicating a number of reconfigurable intelligent surface elements the first reconfigurable intelligent surface supports per sub-reconfigurable intelligent surface.

20. The apparatus of claim 16, wherein the instructions to transmit the first message are further executable by the processor to cause the apparatus to:
transmit the first message indicating one or more codebook-based or non-codebook based beams supported by the first reconfigurable intelligent surface.

21. The apparatus of claim 16, wherein the instructions to transmit the first message are further executable by the processor to cause the apparatus to:
transmit the first message indicating a duration of time in which the first reconfigurable intelligent surface is capable of switching between configurations of the first reconfigurable intelligent surface.

22. The apparatus of claim 16, wherein the instructions to transmit the first message are further executable by the processor to cause the apparatus to:
transmit the first message indicating a granularity of weights associated with reconfigurable intelligent surface elements of the first reconfigurable intelligent surface.

23. The apparatus of claim 16, wherein the instructions to transmit the first message are further executable by the processor to cause the apparatus to:
transmit the first message indicating whether the first reconfigurable intelligent surface is capable of switching configurations across frequencies, indicating a bandwidth size over which the first reconfigurable intelligent surface is capable of switching configurations, indicating one or more modem types the first reconfigurable intelligent surface is configured with, or a combination thereof.

24. The apparatus of claim 16, wherein the instructions are further executable by the processor to cause the apparatus to:
receive a signal indicating a set of one or more communication scheme identifiers, each communication scheme identifier associated with a set of one or more network entities and a communication type, wherein the communication type is one of spatial division multiplexing, frequency division multiplexing, or time division multiplexing.

25. The apparatus of claim 24, wherein the instructions are further executable by the processor to cause the apparatus to:
receive a trigger to perform a training procedure, the trigger comprising a communication scheme identifier from the set of one or more communication scheme identifiers, a set of network entities involved in the training procedure, the communication type associated with the training procedure, a reconfigurable intelligent surface identifier to be used for the training procedure, or a combination thereof; and
perform the training procedure in accordance with the trigger to determine one or more preferred reconfigurable intelligent surface beams associated with the training procedure.

26. The apparatus of claim 16, wherein the instructions to receive the third message are further executable by the processor to cause the apparatus to:
receive the third message indicating a communication scheme identifier, the communication scheme identifier indicative of the configuration for the first reconfigurable intelligent surface for the communications between the first reconfigurable intelligent surface and the one or more network entities.

27. The apparatus of claim 16, wherein the instructions are further executable by the processor to cause the apparatus to:
receive a signal indicating one or more parameters associated with the communications between the first reconfigurable intelligent surface and the one or more network entities, wherein the one or more network entities are each a transmission and reception point.

28. The apparatus of claim 16, wherein the instructions are further executable by the processor to cause the apparatus to:
adjust the configuration of the first reconfigurable intelligent surface in accordance with the configuration indicated in the third message.

29. An apparatus for wireless communications, comprising:
means for transmitting a first message indicating a class of a first reconfigurable intelligent surface of one or more reconfigurable intelligent surfaces served by a reconfigurable intelligent surface controller, the class associated with one or more capabilities of the first reconfigurable intelligent surface;
means for receiving a second message that includes an indication of one or more identifiers associated with the first reconfigurable intelligent surface, a quantity of the one or more identifiers associated with the first reconfigurable intelligent surface based at least in part on the class associated with the first reconfigurable intelligent surface; and
means for receiving a third message indicating, via the one or more identifiers, a configuration for the first reconfigurable intelligent surface for communications between the first reconfigurable intelligent surface and one or more network entities.

30. A non-transitory computer-readable medium storing code for wireless communications, the code comprising instructions executable by a processor to:
transmit a first message indicating a class of a first reconfigurable intelligent surface of one or more reconfigurable intelligent surfaces served by a reconfigurable intelligent surface controller, the class associated with one or more capabilities of the first reconfigurable intelligent surface;
receive a second message that includes an indication of one or more identifiers associated with the first reconfigurable intelligent surface, a quantity of the one or more identifiers associated with the first reconfigurable intelligent surface based at least in part on the class associated with the first reconfigurable intelligent surface; and
receive a third message indicating, via the one or more identifiers, a configuration for the first reconfigurable intelligent surface for communications between the first reconfigurable intelligent surface and one or more network entities.
